(19) United States
(12) Patent Application Publication
(10) Pub. No.: US 2014/0121119 A1
(43) Pub. Date: May 1, 2014

(54) Substance Identification Methods Using Pooling

(71) Applicant: AMPLICON EXPRESS, INC., Pullman, WA (US)

(72) Inventors: Keith E. Stormo, Moscow, ID (US); QuanZhou Tao, Pullman, WA (US); Robert H. Bogden, Moscow, ID (US); Evan K. Hart, Moscow, ID (US)

(73) Assignee: Amplicon Express, Inc., Pullman, WA (US)

(21) Appl. No.: 13/664,370

(22) Filed: Oct. 30, 2012

(51) Int. Cl. C40B 20/06

(52) U.S. Cl. 506/5

(57) ABSTRACT

A substance identification method includes combining substances into four or more intermediate subpools in wells of a subpool plate and repooling the intermediate subpools into a number of final screening pools based on a repooling design providing the subpooled substances in at least three different final screening pools. The repooling design determines coordinates locating well positions for the substances. Another substance identification method includes using a two-dimensional array of wells arranged in rows and a number of columns that is at least 1.5 times the rows. Substances in the wells are combined into a number of screening pools. Individual screening pools include substances from wells having a row identifier in common with one other well. A pooling design provides the pooled substances in two different screening pools. The pooling design determines coordinates locating well positions for the substances.

### RELATED APPLICATION DATA

The present application is a continuation-in-part of U.S. application Ser. No. 10/841,375, filed May 5, 2004, entitled “Pool and Superpool Matrix Coding and Decoding Designs and Methods” and now U.S. Pat. No. 8,301,388, which claims the benefit of priority under 35 U.S.C. §119 to U.S. Provisional App. No. 60/467,912, filed May 5, 2003, entitled “Pool and Superpool matrix provisional application,” both which are herein incorporated by reference.

### TECHNICAL FIELD

This application pertains to substance identification methods using pooling.

### BACKGROUND

Pooled biological material, such as DNA, RNA, proteins, and the like, may be screened by a wide variety of methods, such as sequencing, PCR (Polymerase Chain Reaction), DNA/DNA hybridization, DNA/RNA hybridization, RNA/RNA hybridization, single strand DNA probing, protein/protein hybridization, and a wide variety of additional methods. References describing many of these methods include Ausubel et. al., “Short Protocols in Molecular Biology,” Wiley and Sons, New York and Sambrook et. al, “Molecular Cloning, A Laboratory Manual,” Cold Spring Harbor Press, New York, as well as numerous others. Also referenced are U.S. Pat. No. 5,780,222 (Method of PCR Testing of Pooled Blood Samples) and its references cited therein. Further referenced are U.S. Pat. Nos. 6,126,074 and 6,477,669 and their references cited therein, including those pertaining to Veterbi, Reed-Solomon, and other Error Correction and Data Compression Coding schemes.

### BRIEF DESCRIPTION OF THE DRAWINGS

Some embodiments are described below with reference to the following accompanying drawings.

FIG. 1 is an entire BAC Library comprised of BAC clones in individual wells of 120, 384-well plates, designated as Superpools 1-10 (SP1-10).

FIG. 2 is the Library Code Superpool Collection plate copy #1 having 96 wells.

FIG. 3A is the SP1 with 12 plates having a clone address in plate #8.

FIG. 3B is the SP1 with 16 rows having a clone address in row #4.

FIG. 3C is the SP1 with 24 columns having a clone address in column #16.

FIG. 3D is the SP1 with 24 diagonals having a clone address in diagonal #6 as specified in table 4.

FIG. 4 is the small high resolution pools of the plate, row, column, and diagonal samples of DNA, cDNA or proteins with a positive and negative control in wells E2 and F2 respectively.

FIG. 5 is the further re-pooling of a subset of the wells of FIG. 4 onto the Matrix Pool Plate or specific repooling designs in a Plate, Row, Column, and Diagonal matrix loading pattern.

FIG. 6 is a grid representing 384 wells of a plate.

FIGS. 7 and 8 are grids representing 384 wells of logical arrays.

FIGS. 9a and 9b combined is a grid representing wells of a logical array including five 384-well plates; FIG. 9b is a continuation of 9a on another page.

FIG. 10 is a grid representing one of the plates in FIGS. 9a and 9b.

FIGS. 11 and 12 are grids representing wells of a logical array including twelve 384-well plates.

FIGS. 13 and 14 are grids representing 384 wells of a logical array.

### DETAILED DESCRIPTION

The embodiments herein allow the incorporation of “loss-less information compression and error correction” or other known error correction strategies to increase the robustness of identification with significantly reduced numbers of samples to be processed by the end user. By having the samples pooled again after collection, it is possible to drastically reduce manipulations by the end user while still keeping very fine detail in the identification of the individual samples or populations originally pooled. Error-correction methods are well known in the computer data transmission field, but have not been used in the pooling of biological or chemical samples. Such methods allow a large reduction in the number of experiments to identify the specific biological sample or population containing a region of interest.

The embodiments herein include screening methods where the entire “pooling strategy” used is determined a priori. It is possible to conceive strategies where the strategy used in subsequent levels of processing depends on the outcome of previous levels, and such methods may increase efficiency.

The pooled material can be from individuals or a population. In order to reduce the analysis time, materials and expense, the pooling of small, high resolution pools in a matrix allows for a lower number of samples to be analyzed. The resulting high resolution data obtained from screening matrix pools are equivalent to the data obtained if the researcher had analyzed the complete set of small pools (much more expensive, time consuming, and difficult). The embodiments also give the added advantage of having two positive signals for identification. This reduces errors associated with a false positive when only one signal is obtained for identification, as in known methods.

The matrix pooling can be just for one superpool. Alternatively, it can be a matrix of a variety of different superpools and/or across a variety of different types of pools to allow the screening of the complete library with just one round of experiments. To do this, each small pool would be added to between 6 and 20 of the collection of re-pooled intermediate or final pools. Then, with the total number of pools of between 40 and 100, the complete library (or any set of biological samples) could be screened with high confidence and the ability to resolve multiple hits. If the library had a large redundancy of signal, the total number of pools could be increased to maintain accurate resolving power of the matrix method. The incorporation of positive controls in a matrix pattern can be used for quality assurance and for assisting in deconvolution if desired.

Biological materials may include Bacterial Artificial Chromosome (BAC) genomic DNA libraries and other biological or chemical libraries like cDNA libraries, protein libraries, RNA libraries, DNA libraries, cellular metabolic libraries, and chemical libraries. The current state of the art in pooling of biological materials for screening includes collecting all of the indexed microtiter plates containing the BAC library and then stacking these plates into a cube. These indexed plates are generally 96, 384, 864 well, or sometimes even 1536 well microtiter plates. The cube is then transected by a number of different planes (usually 4 to 8) which produce a large number of pools from each plane. The collection of all the pools from all of the planes is then screened to identify the clones of interest. This scheme is the current state-of-the-art and can identify multiple clone hits with some degree of reliability to identify multiple targets (i.e., BAC clones) at a specific coordinate.

According to Klein et al., their scheme with 6 planes in a collection of 24,576 BAC's could detect between 2 and 6 BAC's and over 90% could be reliably assigned to a specific coordinate with 184 screening pools (that is, 184 user experiments). S. Asakawa, et al., “Human BAC Library: Construction and Rapid Screening,” Gene, Vol. 191, pp. 69-79 (1979) may disclose some initial steps similar to the embodiments herein in the “Methods I” section on page 72. However, Asakawa requires pooling clones before growth and requires construction of each screening pool directly from the pooled clones after growth.

Embodiments herein may provide beneficial accuracy, efficiency and reduced cost by using at least one additional step of repooling the intermediate subpooled genomic DNA clone DNA into a final screening pool. The individual genomic DNA clone may be in at least three unique final screening pools, such as from three to ten unique final screening pools, or from four to eight.

If the BAC Library is from an organism with a genome larger than 1,000 megabases (Mb, millions of base pairs), the researcher may find that there are very few ambiguous hits in a plate, row, column, and diagonal (PRCD) plate. The Plate, Row, and Column pools correctly identify the clone of interest without the need for the Diagonal Pools. If the Diagonal Pools are only screened to solve the infrequent ambiguity, there would be a reduction in the number of PCR experiments.

A Bac-Bank is a way of storing fragments of DNA, together constituting the whole genome of an organism. The DNA of an organism is (semi) randomly cut in pieces, and these fragments are inserted into bacteria, which are then plated out so that a single colony grows from a single modified bacterium. Only modified bacteria are allowed to grow by using a bacterium that is potentially resistant to a certain antibiotic, and whose resistance is “switched on” by the presence of a foreign DNA fragment (insert), and by using a growth medium containing the antibiotic. The resulting (potentially) unique colonies of bacteria are then picked up individually and transferred to the wells of 384-well plates. The resulting stack of plates holding a large number of unique bacteria, ideally containing the whole genome of the original organism, is known as a “Bac-Bank”. It serves as a research database of the genome of the original organism. This database can be searched for fragments of DNA using PCR techniques.

Pooling is a method that allows one to quickly and economically search a Bac-Bank for the presence of certain DNA fragments. A Bac-Bank normally contains a large number of clones (˜100,000). Testing all clones individually for the presence of a fragment of DNA occurring only a few times (typically less than 100 times) in the original organism's genome is prohibitively expensive and laborious. When pooling is used, the DNA of several clones is gathered into a much lower number of wells (pools), every well containing DNA from several clones and every clone's DNA being present in multiple wells. The distribution pattern (“pooling method,” “pooling strategy,” or“rule-set”) is designed in such way that, when using PCR reactions to screen the pools, a pattern (of PCR reaction results) emerges that may be unique to the clone(s) having the required properties.

A simple example: take a 384-well plate having 16 rows of 24 columns; imagine pooling all wells horizontally and vertically, resulting in 16 row-pools and 24 column pools. If a single clone in this plate has a certain property, only the column-pool and the row-pool that particular clone is in will display a positive reaction when screened; the other 38 pools will be negative. Using only 40 PCR reactions it is therefore possible to pinpoint the positive clone in this 384-well plate; almost a tenfold reduction in labor and cost. As long as there are relatively few individuals with a certain property there are few errors. For properties that are shared among many individuals pooling methods may break down (yield incorrect results, either false-positives or (worse) false-negatives), and when this happens one has to resort to screening the clones individually.

Most often the individual clones in Bac-Bank are identified/labeled according to some hierarchical structure dictated by the physical properties of the Bac-Bank. The number of dimensions of a Bac-Bank is then related to the hierarchical structure of the storage format.

An example: the clones of a Bac-Bank are individually stored in wells on a plate. The wells are arranged in a rectangular pattern of rows and columns. If the plate constitutes the whole Bac-Bank, then the Bac-Bank can be viewed as one-dimensional if all the wells on the plate have consecutive numbers from left to right and top to bottom. One single parameter (well number) suffices to address every individual clone/well on the plate, and therefore the Bac-Bank is one-dimensional. A more natural approach in this example would be to address each well by its column and row numbers; then we would need two parameters to address an individual well, and therefore the same Bac-Bank can be two-dimensional as well.

For a larger Bac-Bank one plate would not suffice, and we could give each plate a separate ID code. This would add one coordinate to the number of coordinates required to address each individual well, and therefore there is one more dimension in this case than there would be for a single plate. Another approach is to store the well-plates in boxes of (for example) 10; each plate itself would then have two parameters (coordinates) for an address: the box number and (within that box) the plate number.

All these items are a matter of choice and, therefore, the number of dimensions of a Bac-Bank is a choice as well. It is even possible to use several different addressing schemes without imposing any structure upon this number/code. But, one may also choose to address an individual well as “[C,23,4,A,6]”, when the clone is located in fridge C, box 23, plate 4, column A, and row 6.

It is noteworthy that it is most convenient to have some sort of logical structure related to the physical location of a clone. Such logical structure helps in finding individual clones faster and, most often, there is also a relation between this logical/physical organization and the way the Bac-Bank is pooled. In most examples herein, it is assumed that the Bac-Bank includes 300 plates of 24×16 wells and that the Bac-Bank is three-dimensional.

It will be readily apparent that there are a number of benefits may arise from the embodiments, including but not limited to:

1. Higher resolution deconvolution of complex data without as many analysis reactions.

2. Analyzing a two, three, or more-dimensional matrix of pools allows significant reduction in analysis reactions while retaining a high degree of specificity.

3. The incorporation of loss-less compression and error-correction into the pooling strategy allows improved robustness of analysis and identification of individuals from the pools with increased effectiveness while reducing the numbers of analyses.

4. Significantly reducing the number of analysis reactions used by other less sophisticated pooling systems if a matrix re-pooling design is utilized.

5. As the analytical methods improve, the ability of re-pooling pools (that currently are at the limits of detection) is another significant benefit.

Embodiments herein are distinguished from known methods in that a collection of substances is systematically divided into smaller subsets which are then re-pooled to make the final screening pools. The pooled material can be from individual samples or a population of samples. In order to reduce the analysis time, materials and expense, the pooling of high resolution small pools in a matrix allows for a lower number of user experiments to have higher resolution (as if the researcher had analyzed the complete set of small pools).

One embodiment includes a two-step method that first screens for a superpool in which an item of interest appears. Then, that specific superpool's pools are re-pooled into matrix pools (which are 36 matrix pools instead of 76 pools). The matrix pools screened in this method also give the added advantage of having two or more positive signals for identification. This reduces the current state-of-the-art limitations associated with a false positive and/or false negative experimental result when only one signal is obtained for identification.

The Round I PCR may be performed on all of the Superpools containing all BAC clones in the Library. Each Superpool may contain 4,608 individual BAC clones. The results from Round I of PCR identify Superpool BAC clone(s) with the sequence of interest (there may be more than one Superpool identified). The researcher may choose to pursue one or more positive hits from the Round I PCR.

The Round II PCR may be performed on the Matrix Pools for the specific Superpool identified in Round I PCR. Round II PCR uses 36 PCR experiments plus controls (for each positive hit pursued from Round I PCR). The results from Round II PCR allow the researcher to identify the plate and well position for several positive hits and to rule out many potential false positives (in the particular Superpool(s) being pursued). In comparison, using a known plate/row/column/diagonal strategy, Round II PCR screening of PROD pools requires 76 PCR reactions plus controls. The Matrix system reduces the PCR experiments by 50%.

The Matrix Pools are PROD pools combined so that EACH of these PROD pools is contained in TWO unique Matrix Pools. There are a total of 36 Matrix Pools for each Superpool. Eight Matrix Plate Pools (MPP), eight Matrix Row Pools (MRP), 10 Matrix Column Pools (MCP) and 10 Matrix Diagonal Pools (MDP). There are at most 1,152 individual BAC clones inside each Matrix Pool well.

The matrix pooling can be just in one superpool. Alternately, it can be a matrix of a variety of different superpools and/or across a variety of different types of pools to allow the screening of the complete library with just one round of experiments. To do this, each small pool may be combined with any number (generally between six and many thousands depending on the sensitivity/robustness of the user's experimental screening strategy) of final collection pools (which are re-pooled intermediate pools). For this example we'll use the range of between 6 and 20 collection pools (fully compatible with a PCR based screening technology). Then, with the total number of pools of between 40 and 180, or between 80 and 96, the complete library may be screened with high confidence and the ability to resolve multiple samples in the library containing an identical region of interest. If the library had a large redundancy of signal, the total number of pools could be increased to maintain accurate resolving power of the matrix methodology. The incorporation of positive controls in a matrix pattern can be used for quality assurance and for assisting in deconvolution, if desired.

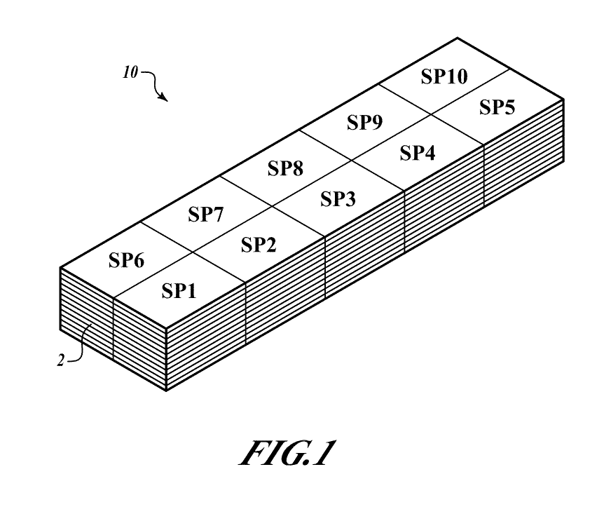

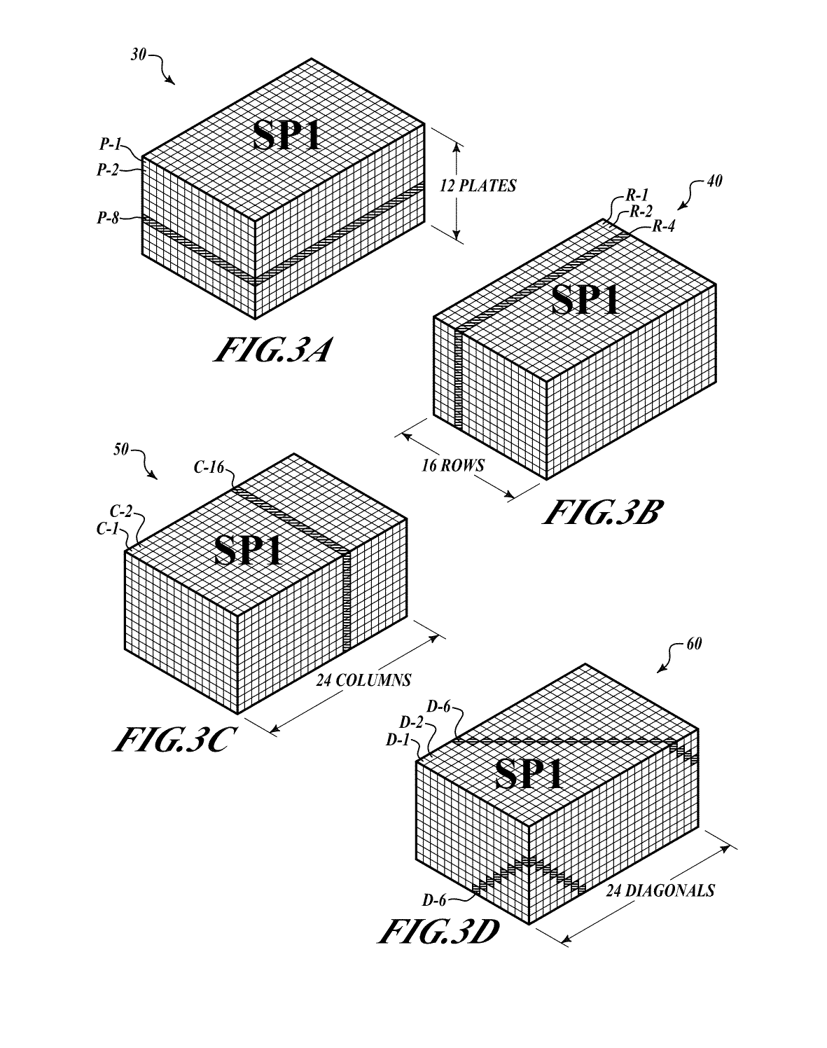

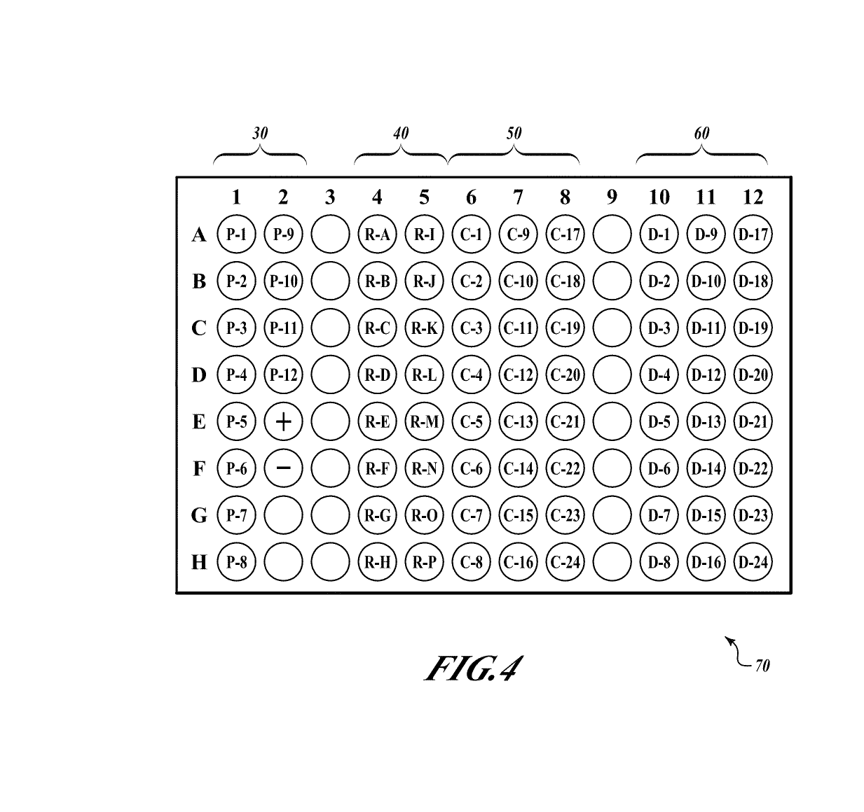

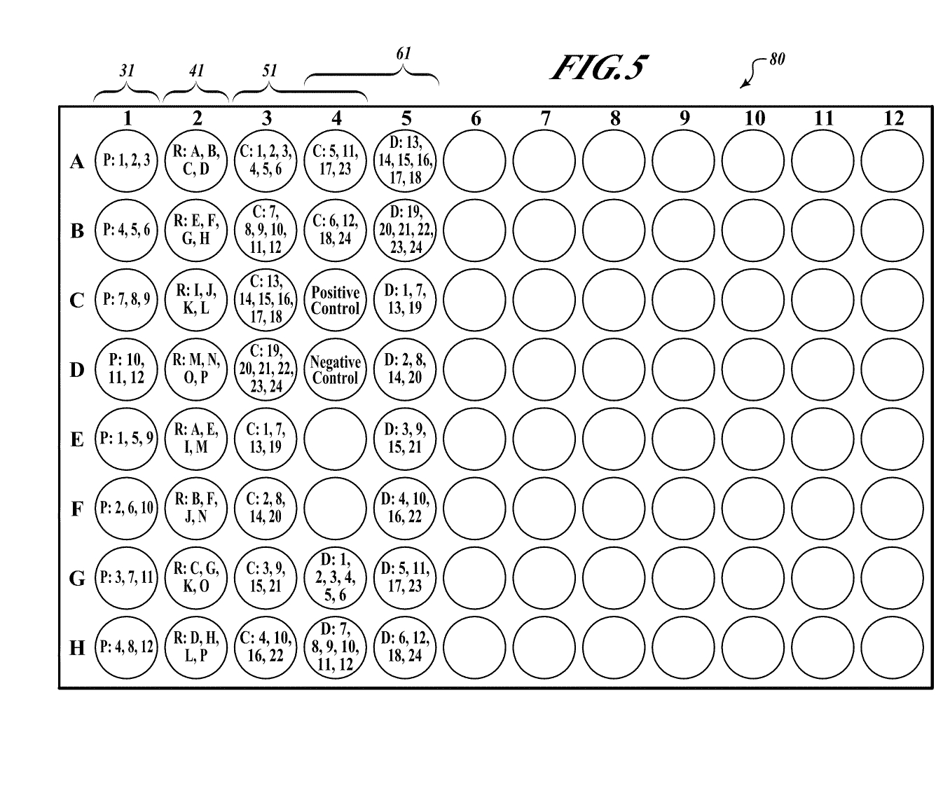

FIGS. 1-5 are a graphical representation of an embodiment. Example 2, Tables 6 and 7 are alternate embodiments of FIG. 3D and FIG. 4 respectively. Tables 8-11 represent additional alternative embodiments of specific repooling designs as depicted in FIG. 5. And Tables 12-16 are data from additional embodiments of the design techniques. FIG. 1 represents ten Superpools of the entire BAC Library 10 containing 120, 384 well-plates 2 stacked on top of each other in ten sets of twelve plates. A wide, almost limitless set of indexed microtiter plates may be used for plates 2.

After compiling the entire BAC Library 10, the researcher receives two identical Superpool Collection Plates that are then used for Round I PCR. Specifically, FIG. 1 is a combined stack of ten Superpools (SP1-SP10). Each Superpool has a stack of twelve plates 2 stacked upon each other. The plates could be any multi-well unit that can be arranged into a hierarchical structure. Claimed herein are 96, 384, 864, and 1536-well units.

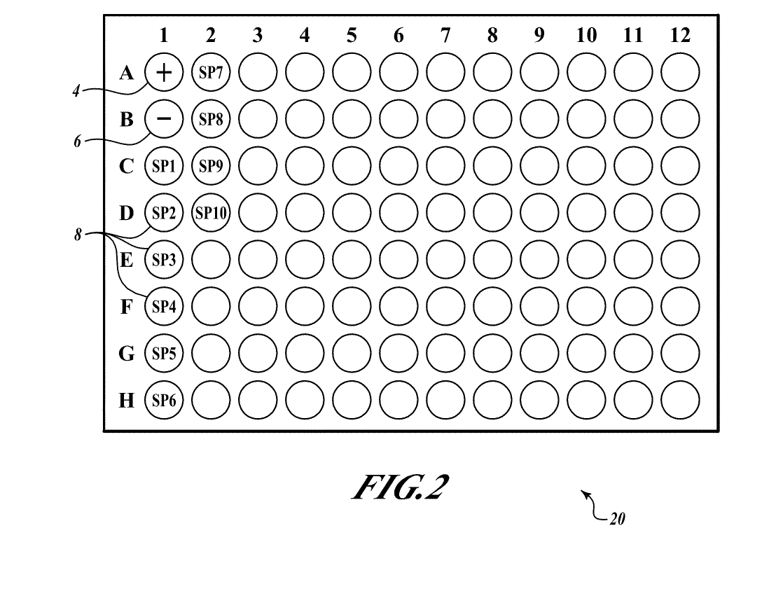

In FIG. 2 a 96-well Superpool Plate 20 comes with a positive (at A1) control 4 and a negative (at B1) control 6 and a sample from individual Superpools 8. Superpool plate 20 provides the template for at least 800 PCR experiments. After receiving Round I PCR gel electrophoresis results, the researcher determines which Superpool to screen for Round II PCR.

In FIG. 3, any of Superpools SP-1 to SP-10 may be separated into pools of plates, rows, columns, and diagonals, which are all based on the hierarchical structure for the clone of interest to allow the researcher to find the specific coordinate or unique address of the well position with the clone of interest. At least three of these four hierarchical structures (plate, row, column, and diagonals) may be used or any combination of three of the four hierarchical structures to insure or guarantee finding the specific coordinate well position with the clone of interest through iteration or redundancy (e.g., FIG. 3D diagonal pool, plus FIG. 3A plate pool, plus FIG. 3C column pool). Again, FIGS. 3A-3D represent a Superpool with a stack of 12 plates with 384 wells. FIGS. 3A-D use four different search patterns to find the precise well having the clone of interest. FIG. 3A identifies the plate of interest in plate pool 30 of SP1, e.g., plate P-8. FIG. 3B identifies the row of interest in row pool 40 of SP1, e.g. row R-4. FIG. 3C identifies the column of interest in column pool 50 of SP1, e.g. column C-16. FIG. 3D identifies the diagonal of interest in diagonal pool 60 of SP1, e.g. diagonal D-6.

DNA or protein samples in Superpool SP1 from the plates of plate pool 30, the rows of row pool 40, the columns of column pool 50, and the diagonals of diagonal pool 60 are sequentially pooled as represented in FIG. 4, onto a 96-well plate 70. In FIG. 5, a plate repool 31, a row repool 41, a column repool 51, and a diagonal repool 61 include repooled DNA on a 96-well plate 80 with positive and negative controls at C4 and D4, respectively. Well plate 80 is a Matrix Pool Plate. This combination further narrows the search for the well with the clone of interest. FIG. 4 depicts the intermediate subpools in the hierarchical structure plate pool 30, row pool 40, column pool 50, and diagonal pool 60 that were generated by processing individual subpools to extract the material according to the hierarchical structure. FIG. 4 is where the isolated material from the subpools is stored in a stable form before repooling the intermediate subpooled material into the Final Screening Pools, as shown in FIG. 5.

Material from the intermediate subpools is further combined and repooled into the Matrix Pool Plate of FIG. 5. The researcher will then receive two identical Matrix Pool Plates as in FIG. 5 for a Superpool to use to perform Round II PCR. FIG. 5 represents the repooling of the intermediate subpooled material into a number of final screening pools based on a specific repooling design, wherein individual information is in at least three final screening pools, or at least four final screening pools and no more than eight final screening pools. When plate 80 of final screening pool materials is screened, the specific coordinates are determined which allows the identification of the well position of the clone of interest.

### Example 1

This description is based on 384 well index plates, but it could be used with other plate formats as well with appropriate considerations. It is also based on a BAC genomic DNA library comprised of individual BAC clones, but it could be used with a large variety of biological sample collections or chemical sample collections. The system includes a collection of multiple Superpools that are screened during First Round PCR, to determine which set of Matrix Pools to screen during Second Round PCR. The total number of Superpools is determined by the total number of clones in the BAC library. Each Superpool has its own 96-well plate of corresponding Matrix Pools.

Superpools: Each superpool includes twelve consecutive 384-well plates from a BAC library. DNA is prepared by growing EACH BAC CLONE separately (to avoid growth competition between BAC clones) then combining the 4,608 cultures into one large-scale BAC prep. The Superpool of BAC DNA is then aliquoted onto a 96-well plate. Superpool SP-1 has all the BAC clones in the first twelve plates of the BAC library (Plate 001 to Plate 012). Superpool SP-2 has all the BAC clones in the second twelve plates of the BAC library (Plate 013 to Plate 024). This naming continues for the entire library.

Matrix Pools: For each superpool there is one set of Matrix Pools (this set of 36 Matrix Pools are aliquoted onto a Matrix Pool Plate. The Matrix Pools of Superpool SP1 are named Matrix Plate Pools, Matrix Row Pools, Matrix Column Pools, and Matrix Diagonal Pools.

Matrix Plate Pools 1 MPP-A1 through 1 MPP-H1 for the 8 wells that contain the matrix of plates 1-12 in Superpool SP1. Each Matrix Plate Pool contains 1,152 clones. Table 1 indicates the clones in each well. FIG. 5 shows plate repool 31, which also describes the content of the Matrix Plate Pools, namely, the plate numbers of the clones in respective Matrix Pools. The same process is repeated for as many superpools as are needed for the complete library.

TABLE 1
Matrix Plate Pools

| Matrix well # | Clones contained in plate # of the specific superpool |
|---|---|
| A1 | 1, 2, 3 |
| B1 | 4, 5, 6 |
| C1 | 7, 8, 9 |
| D1 | 10, 11, 12 |
| E1 | 1, 5, 9 |
| F1 | 2, 6, 10 |
| G1 | 3, 7, 11 |
| H1 | 4, 8, 12 |

Matrix Row Pools 1 MRP-A2 through 1 MRP-H2 for the 8 wells that contain the matrix of rows A-P in Superpool SP1. Each Matrix Row Pool contains 1,152 clones for twelve 384 well plates. Table 2 shows the composition of each well in the Matrix Row Pools. FIG. 5 shows row repool 41, which also describes the content of the Matrix Row Pools, namely, the row letters of the clones in respective Matrix Pools.

TABLE 2
Matrix Row Pools.

| Matrix well # | Clones contained in row letter of the specific superpool |
|---|---|
| A2 | A, B, C, D |
| B2 | E, F, G, H |
| C2 | I, J, K, L |
| D2 | M, N, O, P |
| E2 | A, E, I, M |
| F2 | B, F, J, N |
| G2 | C, G, K, O |
| H2 | D, H, L, P |

Matrix Column Pools 1 MPP-A3 through 1 MPP-B4 for the 10 wells that contain the matrix of columns 1-24 in Superpool SP1. The Matrix Column Pools in wells A3 through D3 have 1,152 clones (6 different columns X 192 column wells/plate=1,152 clones per Matrix Column Pool). The Matrix Column Pools in wells E3 through B4 contain 768 clones (4 different columns X 192 column wells/plate=768 clones per Matrix Column Pool). Table 3 shows the composition of each well in the Matrix Column Pools. FIG. 5 shows column repool 51, which also describes the content of the Matrix Column Pools, namely, the column numbers of the clones in respective Matrix Pools.

TABLE 3
Matrix Column Pools

| Matrix well # | Clones contained in column # of the specific Superpool |
|---|---|
| A3 | 1, 2, 3, 4, 5, 6 |
| B3 | 7, 8, 9, 10, 11, 12 |
| C3 | 13, 14, 15, 16, 17, 18 |
| D3 | 19, 20, 21, 22, 23, 24 |
| E3 | 1, 7, 13, 19 |
| F3 | 2, 8, 14, 20 |
| G3 | 3, 9, 15, 21 |
| H3 | 4, 10, 16, 22 |
| A4 | 5, 11, 17, 23 |
| B4 | 6, 12, 18, 24 |

Matrix Diagonal Pools 1MDP-G4 through 1MDP-H5 for the 10 wells that contain the matrix of diagonals 1-24 in Superpool SP1. The diagonal pools are a collection of clones from all twelve plates in one superpool that has been transected by a plane that goes diagonal in an XY plane and diagonal in a XZ plane through the 12 plates. The diagonals are named by the number of the column that the clone from row A on plate 1 of the specific diagonal. The Matrix Diagonal Pools in wells G4 through B5 have 1,152 clones (6 different diagonals X 12 plates/diagonal X 16 column wells/plate=1,152 clones per Matrix Diagonal Pool). The Matrix Diagonal Pools in wells C5 through H5 contain 768 clones (4 different diagonals X 12 plates/diagonal X 16 column wells/plate=768 clones per Matrix Diagonal Pool). Table 4 shows the exact location by plate number, row letter, and column number of each well included in each diagonal pool. Notably, as the diagonal number (column number) approaches 24, the diagonal pool wraps back to column 1 for a 16 row by 24 column plate. Diagonal pool composition is depicted graphically by FIG. 3D and corresponds to the construction of diagonal pool 60 in FIG. 4. Table 5 shows the composition of the Matrix Diagonal Pools. FIG. 5 shows diagonal repool 61, which also describes the content of the Matrix Diagonal Pools, namely, the diagonal numbers of the clones in respective Matrix Pools.

TABLE 4
Diagonal Pool Composition

| Diago- | |
|---|---|
| nal | |
| pool | Clones contained in the specific superpool labeled by |
| # | (plate, row, column) |
| 1 | 1A1, 1B2, 1C3 . . . 1P16; 2A2, 2B3, 2C4 . . . 2P17; . . . ; |
| | 12A12, 12B13, 12C14 . . . 12P3 |
| 2 | 1A2, 1B3, 1C4 . . . 1P17; 2A3, 2B4, 2C5 . . . 2P18; . . . ; |
| | 12A13, 12B14, 12C15 . . . 12P4 |
| 3 | 1A3, 1B4, 1C5 . . . 1P18; 2A4, 2B5, 2C6 . . . 2P19; . . . ; |
| | 12A14, 12B15, 12C16 . . . 12P5 |
| 4 | 1A4, 1B5, 1C6 . . . 1P19; 2A5, 2B6, 2C7 . . . 2P20; . . . ; |
| | 12A15, 12B16, 12C17 . . . 12P6 |
| 5 | 1A5, 1B6, 1C7 . . . 1P20; 2A6, 2B7, 2C8 . . . 2P21; . . . ; |
| | 12A16, 12B17, 12C18 . . . 12P7 |
| 6 | 1A6, 1B7, 1C8 . . . 1P21; 2A7, 2B8, 2C9 . . . 2P22; . . . ; |
| | 12A17, 12B18, 12C19 . . . 12P8 |
| 7 | 1A7, 1B8, 1C9 . . . 1P22; 2A8, 2B9, 2C10 . . . 2P23; . . . ; |
| | 12A18, 12B19, 12C20 . . . 12P9 |
| 8 | 1A8, 1B9, 1C10 . . . 1P23; 2A9, 2B10, 2C11 . . . 2P24; . . . ; |
| | 12A19, 12B20, 12C21 . . . 12P10 |
| 9 | 1A9, 1B10, 1C11 . . . 1P24; 2A10, 2B11, 2C12 . . . 2P1; . . . ; |
| | 12A20, 12B21, 12C22 . . . 12P11 |
| 10 | 1A10, 1B11, 1C12 . . . 1P1; 2A11, 2B12, 2C13 . . . 2P2; . . . ; |
| | 12A21, 12B22, 12C23 . . . 12P12 |
| 11 | 1A11, 1B12, 1C13 . . . 1P2; 2A12, 2B13, 2C14 . . . 2P3; . . . ; |
| | 12A22, 12B23, 12C24 . . . 12P13 |
| 12 | 1A12, 1B13, 1C14 . . . 1P3; 2A13, 2B14, 2C15 . . . 2P4; |
| | . . . ; 12A23, 12B24, 12C1 . . . 12P14 |
| 13 | 1A13, 1B14, 1C15 . . . 1P4; 2A14, 2B15, 2C16 . . . 2P5; . . . ; |
| | 12A24, 12B1, 12C2 . . . 12P15 |
| 14 | 1A14, 1B15, 1C16 . . . 1P5; 2A15, 2B16, 2C17 . . . 2P6; . . . ; |
| | 12A1, 12B2, 12C3 . . . 12P16 |
| 15 | 1A15, 1B16, 1C17 . . . 1P6; 2A16, 2B17, 2C18 . . . 2P7; . . . ; |
| | 12A2, 12B3, 12C4 . . . 12P17 |
| 16 | 1A16, 1B17, 1C18 . . . 1P7; 2A17, 2B18, 2C19 . . . 2P8; . . . ; |
| | 12A3, 12B4, 12C5 . . . 12P18 |
| 17 | 1A17, 1B18, 1C19 . . . 1P8; 2A18, 2B19, 2C20 . . . 2P9; . . . ; |
| | 12A4, 12B5, 12C6 . . . 12P19 |
| 18 | 1A18, 1B19, 1C20 . . . 1P9; 2A19, 2B20, 2C21 . . . 2P10; . . . ; |
| | 12A5, 12B6, 12C7 . . . 12P20 |
| 19 | 1A19, 1B20, 1C21 . . . 1P10; 2A20, 2B21, 2C22 . . . 2P11; . . . ; |
| | 12A6, 12B7, 12C8 . . . 12P21 |
| 20 | 1A20, 1B21, 1C22 . . . 1P11; 2A21, 2B22, 2C23 . . . 2P12; . . . ; |
| | 12A7, 12B8, 12C9 . . . 12P22 |
| 21 | 1A21, 1B22, 1C23 . . . 1P12; 2A22, 2B23, 2C24 . . . 2P13; . . . ; |
| | 12A8, 12B9, 12C10 . . . 12P23 |
| 22 | 1A22, 1B23, 1C24 . . . 1P13; 2A23, 2B24, 2C1 . . . 2P14; . . . ; |
| | 12A9, 12B10, 12C11 . . . 12P24 |
| 23 | 1A23, 1B24, 1C1 . . . 1P14; 2A24, 2B1, 2C2 . . . 2P15; . . . ; |
| | 12A10, 12B11, 12C12 . . . 12P1 |
| 24 | 1A24, 1B1, 1C2 . . . 1P15; 2A1, 2B2, 2C3 . . . 2P16; . . . ; |
| | 12A11, 12B12, 12C13 . . . 12P2 |

Table 4 is but an example of a diagonal scheme that is non-redundant with other pools. The embodiments are not limited to one specific diagonal scheme since there are additional diagonal scheme that can be used as alternatives to this diagonal scheme.

TABLE 5
Matrix Diagonal Pools

| Matrix well # | Clones contained in diagonal # of the specific superpool |
|---|---|
| G4 | 1, 2, 3, 4, 5, 6 |
| H4 | 7, 8, 9, 10, 11, 12 |
| A5 | 13, 14, 15, 16, 17, 18 |
| B5 | 19, 20, 21, 22, 23, 24 |
| C5 | 1, 7, 13, 19 |
| D5 | 2, 8, 14, 20 |
| E5 | 3, 9, 15, 21 |
| F5 | 4, 10, 16, 22 |
| G5 | 5, 11, 17, 23 |
| H5 | 6, 12, 18, 24 |

After screening the matrix pools by one of many possible methods, the identity of a specific positive clone from the library can be determined. The specific identification can be determined by a number of ways. If the pool design and matrix design are written or available in electronic form, the unique clone can be identified by a visual or electronic search. There can also be algorithms written based on the pool and matrix designs that can identify the unique clone.

### Example 2

The second example describes a method to form a matrix of a variety of different superpools and/or across a variety of different types of pools to allow the screening of the complete library with just one round of experiments. To do this, each small pool or subpool would be added to between 6 and 20 of the collection of re-pooled intermediate or final pools. Then with the total number of pools of between 40 and 180, and between 80 and 94, the complete library could be screened with high confidence and the ability to resolve multiple hits. If the library had a large redundancy of signal, the total number of pools could be increased to maintain accurate resolving power of the matrix solution. Note: 94 experiments is a convenient number, because current screening technologies are performed on a 96-well index plate format (94 experiments will allow room for a positive control and negative control).

In the second example, an additional method allows the complete library to be screened in one step while still maintaining the resolution of the superpool individual pools formed in Example 1. Example 2 further illustrates the benefits and possibilities of the embodiments. This example is also based on 384 well index plates, but it could be used with other plate formats as well with appropriate considerations. It is also based on a BAC genomic DNA library comprised of individual BAC clones, but it could be used with a large variety of biological collections. The superpools will be composed of eight 384 well plates per superpool and with 10 superpools combined into one large set of matrix pools. Therefore there will be 80 plates (30,720 individual BAC clones in the library) in this one matrix screening that can be tested with a limited number of tests while still maintaining good resolution to an individual clone or may possibly requires screening a few clones during the clone confirmation test directly on the clone(s) of interest. This scheme also allows a single set of experiments (instead of two sets of experiments as described in Example 1).

In this scheme, the individual superpools are numbered so that each individual ⅓ plate, row, column and diagonal pool has a unique number. Since there are 88 pools per superpool and ten superpools in this example, there are a total of 880 individual pools that will be combined into one large set of matrix pools. Depending on the number of redundant clones in the BAC library (a function of the genome size and the insert size of the BAC clones), the idealized degree of redundancy can dramatically improve the ability to identify multiple positive clones in one screening and thus minimize ambiguous results (when the user is analyzing data from the screening experiments).

The first ⅓ plate pools are formed by collecting all of the clones in plate 1 from columns 1-8. Then the second ⅓ plate pool is all of the clones from columns 9-16 of plate one. This continues on until the 24th ⅓ plate pool is from columns 17-24 of plate 8. The twenty-four ⅓ plate pools from superpool two would be considered being in pools 89-112 and so on until the tenth superpool where the ⅓ plate pools would be in pools 793-816.

The row pools would be built the same way as Example 1 but since there are only 8 plates in each superpool, each pool would have 192 clones. All of the clones in row A of the eight plates would be pooled together and these clones would be considered pool number 25. This would continue on in a similar fashion so all of the clones in row B of all eight plates of the superpool would belong to pool 26 (and so on) until finally, the pool of all of the clones in row P of the first eight plates would belong to pool number 40. Similarly, the row pools from the second superpool will be in pools numbered 113-128. This would continue in a similar fashion until all of the superpool individual clones belong to row pools and each are assigned unique numbers.

The column pools would be formed the same way as in Example 1 but since there are only 8 plates in each superpool, each pool would have 128 clones. All of the clones in column 1 of the eight plates would be pooled together and would belong to pool number 41. This would continue on in a similar fashion until all of the clones in column 2 of all eight plates of the superpool would belong to pool 42 (and so on). Until finally, the pool of all of the clones in column 24 of the first eight plates belong to pool number 64. Similarly, the column pools from the second superpool will be in pools numbered 129-152. This would continue in a similar fashion until all of the superpools belong to column pools and each are assigned unique numbers.

The diagonal pools would be formed the same way as in Example 1 but since there are only 8 plates in each superpool, each pool would have 128 clones. See Table 6 for the 8 plate superpool diagonal composition. All of the clones in diagonal 1 of the eight plates would be pooled together and would belong to pool number 65. This would continue on in a similar fashion until all of the clones in diagonal 2 of all eight plates of the superpool would belong to pool 66 (and so on). Until finally, the pool of all of the clones in diagonal 24 of the first eight plates belong to pool number 88. Similarly, the diagonal pools from the second superpool will be in pools numbered 152-176. This would continue in a similar fashion until all of the superpools belong to diagonal pools and each are assigned unique numbers.

To see one design of many possible schemes for identifying a complete set unique pool numbers, see Table 7. Table 7 is designed for 88 pools in each subset (superpool) and ten subset (superpools) in the complete set. These unique pool numbers are used to construct various tested screening pool pooling strategies. Notably, as the column number approaches 24, the diagonal pool wraps back to column 1 for a 16 row by 24 column plate.

Table 6 describes an alternate embodiment for constructing the diagonal pool composition for an 8 plate Superpool.

TABLE 6
Diagonal pool composition for an 8 plate superpool.

| Diago- | |
|---|---|
| nal | |
| pool | clones contained in the specific superpool labeled by |
| # | (plate, row, column) |
| 1 | 1A1, 1B2, 1C3 . . . 1P16; 2A2, 2B3, 2C4 . . . 2P17; . . . ; |
| | 8A8, 8B9, 8C10 . . . 8P23 |
| 2 | 1A2, 1B3, 1C4 . . . 1P17; 2A3, 2B4, 2C5 . . . 2P18; . . . ; |
| | 8A9, 8B10, 8C11 . . . 8P24 |
| 3 | 1A3, 1B4, 1C5 . . . 1P18; 2A4, 2B5, 2C6 . . . 2P19; . . . ; |
| | 8A10, 8B11, 8C12 . . . 8P1 |
| 4 | 1A4, 1B5, 1C6 . . . 1P19; 2A5, 2B6, 2C7 . . . 2P20; . . . ; |
| | 8A11, 8B12, 8C13 . . . 8P2 |
| 5 | 1A5, 1B6, 1C7 . . . 1P20; 2A6, 2B7, 2C8 . . . 2P21; . . . ; |
| | 8A12, 8B13, 8C14 . . . 8P3 |
| 6 | 1A6, 1B7, 1C8 . . . 1P21; 2A7, 2B8, 2C9 . . . 2P22; . . . ; |
| | 8A13, 8B14, 8C15 . . . 8P4 |
| 7 | 1A7, 1B8, 1C9 . . . 1P22; 2A8, 2B9, 2C10 . . . 2P23; . . . ; |
| | 8A14, 8B15, 8C16 . . . 8P5 |
| 8 | 1A8, 1B9, 1C10 . . . 1P23; 2A9, 2B10, 2C11 . . . 2P24; . . . ; |
| | 8A15, 8B16, 8C17 . . . 8P6 |
| 9 | 1A9, 1B10, 1C11 . . . 1P24; 2A10, 2B11, 2C12 . . . 2P1; . . . ; |
| | 8A16, 8B17, 8C18 . . . 8P7 |
| 10 | 1A10, 1B11, 1C12 . . . 1P1; 2A11, 2B12, 2C13 . . . 2P2; . . . ; |
| | 8A17, 8B18, 8C19 . . . 8P8 |
| 11 | 1A11, 1B12, 1C13 . . . 1P2; 2A12, 2B13, 2C14 . . . 2P3; . . . ; |
| | 8A18, 8B19, 8C20 . . . 8P9 |
| 12 | 1A12, 1B13, 1014 . . . 1P3; 2A13, 2B14, 2C15 . . . 2P4; |
| | . . . ; 8A19, 8B20, 8C21 . . . 8P10 |
| 13 | 1A13, 1B14, 1C15 . . . 1P4; 2A14, 2B15, 2C16 . . . 2P5; . . . ; |
| | 8A20, 8B21, 8C22 . . . 8P11 |
| 14 | 1A14, 1B15, 1C16 . . . 1P5; 2A15, 2B16, 2C17 . . . 2P6; . . . ; |
| | 8A21, 8B22, 8C23 . . . 8P12 |
| 15 | 1A15, 1B16, 1C17 . . . 1P6; 2A16, 2B17, 2C18 . . . 2P7; . . . ; |
| | 8A22, 8B23, 8C24 . . . 8P13 |
| 16 | 1A16, 1B17, 1C18 . . . 1P7; 2A17, 2B18, 2C19 . . . 2P8; . . . ; |
| | 8A23, 8B24, 8C1 . . . 8P14 |
| 17 | 1A17, 1B18, 1C19 . . . 1P8; 2A18, 2B19, 2C20 . . . 2P9; . . . ; |
| | 8A24, 8B1, 8C2 . . . 8P15 |
| 18 | 1A18, 1B19, 1020 . . . 1P9; 2A19, 2B20, 2C21 . . . 2P10; |
| | . . . ; 8A1, 8B2, 8C3 . . . 8P16 |
| 19 | 1A19, 1B20, 1C21 . . . 1P10; 2A20, 2B21, 2C22 . . . 2P11; |
| | . . . ; 8A2, 8B3, 8C4 . . . 8P17 |
| 20 | 1A20, 1B21, 1C22 . . . 1P11; 2A21, 2B22, 2C23 . . . 2P12; |
| | . . . ; 8A3, 8B4, 8C5 . . . 8P18 |
| 21 | 1A21, 1B22, 1023 . . . 1P12; 2A22, 2B23, 2C24 . . . 2P13; |
| | . . . ; 8A4, 8B5, 8C6 . . . 8P19 |
| 22 | 1A22, 1B23, 1024 . . . 1P13; 2A23, 2B24, 2C1 . . . 2P14; |
| | . . . ; 8A5, 8B6, 8C7 . . . 8P20 |
| 23 | 1A23, 1B24, 1C1 . . . 1P14; 2A24, 2B1, 2C2 . . . 2P15; . . . ; |
| | 8A6, 8B7, 8C8 . . . 8P21 |
| 24 | 1A24, 1B1, 1C2 . . . 1P15; 2A1, 2B2, 2C3 . . . 2P16; . . . ; |
| | 8A7, 8B8, 8C9 . . . 8P22 |

Table 7 sequentially assigns numbers to individual small pools or subpools from ten consecutive from eight plates so that the subpools may be repooled into final screening pools according to example alternative embodiments depicted in Tables 8-11.

TABLE 7
Unique pool numbers for the ⅓ plate, row,
column and diagonal pools of the first ten superpools.

| | Unique pool numbers for 8 plate superpools 1 through 10. | | | | | | | | | |
|---|---|---|---|---|---|---|---|---|---|---|
| Individual superpool contents | 1 | 2 | 3 | 4 | 5 | 6 | 7 | 8 | 9 | 10 |
| ⅓ plate 1 | 1 | 89 | 177 | 265 | 353 | 441 | 529 | 617 | 705 | 793 |
| ⅓ plate 2 | 2 | 90 | 178 | 266 | 354 | 442 | 530 | 618 | 706 | 794 |
| ⅓ plate 3 | 3 | 91 | 179 | 267 | 355 | 443 | 531 | 619 | 707 | 795 |
| ⅓ plate 4 | 4 | 92 | 180 | 268 | 356 | 444 | 532 | 620 | 708 | 796 |
| ⅓ plate 5 | 5 | 93 | 181 | 269 | 357 | 445 | 533 | 621 | 709 | 797 |
| ⅓ plate 6 | 6 | 94 | 182 | 270 | 358 | 446 | 534 | 622 | 710 | 798 |
| ⅓ plate 7 | 7 | 95 | 183 | 271 | 359 | 447 | 535 | 623 | 711 | 799 |
| ⅓ plate 8 | 8 | 96 | 184 | 272 | 360 | 448 | 536 | 624 | 712 | 800 |
| ⅓ plate 9 | 9 | 97 | 185 | 273 | 361 | 449 | 537 | 625 | 713 | 801 |
| ⅓ plate 10 | 10 | 98 | 186 | 274 | 362 | 450 | 538 | 626 | 714 | 802 |
| ⅓ plate 11 | 11 | 99 | 187 | 275 | 363 | 451 | 539 | 627 | 715 | 803 |
| ⅓ plate 12 | 12 | 100 | 188 | 276 | 364 | 452 | 540 | 628 | 716 | 804 |
| ⅓ plate 13 | 13 | 101 | 189 | 277 | 365 | 453 | 541 | 629 | 717 | 805 |
| ⅓ plate 14 | 14 | 102 | 190 | 278 | 366 | 454 | 542 | 630 | 718 | 806 |
| ⅓ plate 15 | 15 | 103 | 191 | 279 | 367 | 455 | 543 | 631 | 719 | 807 |
| ⅓ plate 16 | 16 | 104 | 192 | 280 | 368 | 456 | 544 | 632 | 720 | 808 |
| ⅓ plate 17 | 17 | 105 | 193 | 281 | 369 | 457 | 545 | 633 | 721 | 809 |
| ⅓ plate 18 | 18 | 106 | 194 | 282 | 370 | 458 | 546 | 634 | 722 | 810 |
| ⅓ plate 19 | 19 | 107 | 195 | 283 | 371 | 459 | 547 | 635 | 723 | 811 |
| ⅓ plate 20 | 20 | 108 | 196 | 284 | 372 | 460 | 548 | 636 | 724 | 812 |
| ⅓ plate 21 | 21 | 109 | 197 | 285 | 373 | 461 | 549 | 637 | 725 | 813 |
| ⅓ plate 22 | 22 | 110 | 198 | 286 | 374 | 462 | 550 | 638 | 726 | 814 |
| ⅓ plate 23 | 23 | 111 | 199 | 287 | 375 | 463 | 551 | 639 | 727 | 815 |
| ⅓ plate 24 | 24 | 112 | 200 | 288 | 376 | 464 | 552 | 640 | 728 | 816 |
| row A | 25 | 113 | 201 | 289 | 377 | 465 | 553 | 641 | 729 | 817 |
| row B | 26 | 114 | 202 | 290 | 378 | 466 | 554 | 642 | 730 | 818 |
| row C | 27 | 115 | 203 | 291 | 379 | 467 | 555 | 643 | 731 | 819 |
| row D | 28 | 116 | 204 | 292 | 380 | 468 | 556 | 644 | 732 | 820 |
| row E | 29 | 117 | 205 | 293 | 381 | 469 | 557 | 645 | 733 | 821 |
| row F | 30 | 118 | 206 | 294 | 382 | 470 | 558 | 646 | 734 | 822 |
| row G | 31 | 119 | 207 | 295 | 383 | 471 | 559 | 647 | 735 | 823 |
| row H | 32 | 120 | 208 | 296 | 384 | 472 | 560 | 648 | 736 | 824 |
| row I | 33 | 121 | 209 | 297 | 385 | 473 | 561 | 649 | 737 | 825 |
| row J | 34 | 122 | 210 | 298 | 386 | 474 | 562 | 650 | 738 | 826 |
| row K | 35 | 123 | 211 | 299 | 387 | 475 | 563 | 651 | 739 | 827 |
| row L | 36 | 124 | 212 | 300 | 388 | 476 | 564 | 652 | 740 | 828 |
| row M | 37 | 125 | 213 | 301 | 389 | 477 | 565 | 653 | 741 | 829 |
| row N | 38 | 126 | 214 | 302 | 390 | 478 | 566 | 654 | 742 | 830 |
| row O | 39 | 127 | 215 | 303 | 391 | 479 | 567 | 655 | 743 | 831 |
| row P | 40 | 128 | 216 | 304 | 392 | 480 | 568 | 656 | 744 | 832 |
| column 1 | 41 | 129 | 217 | 305 | 393 | 481 | 569 | 657 | 745 | 833 |
| column 2 | 42 | 130 | 218 | 306 | 394 | 482 | 570 | 658 | 746 | 834 |
| column 3 | 43 | 131 | 219 | 307 | 395 | 483 | 571 | 659 | 747 | 835 |
| column 4 | 44 | 132 | 220 | 308 | 396 | 484 | 572 | 660 | 748 | 836 |
| column 5 | 45 | 133 | 221 | 309 | 397 | 485 | 573 | 661 | 749 | 837 |
| column 6 | 46 | 134 | 222 | 310 | 398 | 486 | 574 | 662 | 750 | 838 |
| column 7 | 47 | 135 | 223 | 311 | 399 | 487 | 575 | 663 | 751 | 839 |
| column 8 | 48 | 136 | 224 | 312 | 400 | 488 | 576 | 664 | 752 | 840 |
| column 9 | 49 | 137 | 225 | 313 | 401 | 489 | 577 | 665 | 753 | 841 |
| column 10 | 50 | 138 | 226 | 314 | 402 | 490 | 578 | 666 | 754 | 842 |
| column 11 | 51 | 139 | 227 | 315 | 403 | 491 | 579 | 667 | 755 | 843 |
| column 12 | 52 | 140 | 228 | 316 | 404 | 492 | 580 | 668 | 756 | 844 |
| column 13 | 53 | 141 | 229 | 317 | 405 | 493 | 581 | 669 | 757 | 845 |
| column 14 | 54 | 142 | 230 | 318 | 406 | 494 | 582 | 670 | 758 | 846 |
| column 15 | 55 | 143 | 231 | 319 | 407 | 495 | 583 | 671 | 759 | 847 |
| column 16 | 56 | 144 | 232 | 320 | 408 | 496 | 584 | 672 | 760 | 848 |
| column 17 | 57 | 145 | 233 | 321 | 409 | 497 | 585 | 673 | 761 | 849 |
| column 18 | 58 | 146 | 234 | 322 | 410 | 498 | 586 | 674 | 762 | 850 |
| column 19 | 59 | 147 | 235 | 323 | 411 | 499 | 587 | 675 | 763 | 851 |
| column 20 | 60 | 148 | 236 | 324 | 412 | 500 | 588 | 676 | 764 | 852 |
| column 21 | 61 | 149 | 237 | 325 | 413 | 501 | 589 | 677 | 765 | 853 |
| column 22 | 62 | 150 | 238 | 326 | 414 | 502 | 590 | 678 | 766 | 854 |
| column 23 | 63 | 151 | 239 | 327 | 415 | 503 | 591 | 679 | 767 | 855 |
| column 24 | 64 | 152 | 240 | 328 | 416 | 504 | 592 | 680 | 768 | 856 |
| diagonal 1 | 65 | 153 | 241 | 329 | 417 | 505 | 593 | 681 | 769 | 857 |
| diagonal 2 | 66 | 154 | 242 | 330 | 418 | 506 | 594 | 682 | 770 | 858 |
| diagonal 3 | 67 | 155 | 243 | 331 | 419 | 507 | 595 | 683 | 771 | 859 |
| diagonal 4 | 68 | 156 | 244 | 332 | 420 | 508 | 596 | 684 | 772 | 860 |
| diagonal 5 | 69 | 157 | 245 | 333 | 421 | 509 | 597 | 685 | 773 | 861 |
| diagonal 6 | 70 | 158 | 246 | 334 | 422 | 510 | 598 | 686 | 774 | 862 |
| diagonal 7 | 71 | 159 | 247 | 335 | 423 | 511 | 599 | 687 | 775 | 863 |
| diagonal 8 | 72 | 160 | 248 | 336 | 424 | 512 | 600 | 688 | 776 | 864 |
| diagonal 9 | 73 | 161 | 249 | 337 | 425 | 513 | 601 | 689 | 777 | 865 |
| diagonal 10 | 74 | 162 | 250 | 338 | 426 | 514 | 602 | 690 | 778 | 866 |
| diagonal 11 | 75 | 163 | 251 | 339 | 427 | 515 | 603 | 691 | 779 | 867 |
| diagonal 12 | 76 | 164 | 252 | 340 | 428 | 516 | 604 | 692 | 780 | 868 |
| diagonal 13 | 77 | 165 | 253 | 341 | 429 | 517 | 605 | 693 | 781 | 869 |
| diagonal 14 | 78 | 166 | 254 | 342 | 430 | 518 | 606 | 694 | 782 | 870 |
| diagonal 15 | 79 | 167 | 255 | 343 | 431 | 519 | 607 | 695 | 783 | 871 |
| diagonal 16 | 80 | 168 | 256 | 344 | 432 | 520 | 608 | 696 | 784 | 872 |
| diagonal 17 | 81 | 169 | 257 | 345 | 433 | 521 | 609 | 697 | 785 | 873 |
| diagonal 18 | 82 | 170 | 258 | 346 | 434 | 522 | 610 | 698 | 786 | 874 |
| diagonal 19 | 83 | 171 | 259 | 347 | 435 | 523 | 611 | 699 | 787 | 875 |
| diagonal 20 | 84 | 172 | 260 | 348 | 436 | 524 | 612 | 700 | 788 | 876 |
| diagonal 21 | 85 | 173 | 261 | 349 | 437 | 525 | 613 | 701 | 789 | 877 |
| diagonal 22 | 86 | 174 | 262 | 350 | 438 | 526 | 614 | 702 | 790 | 878 |
| diagonal 23 | 87 | 175 | 263 | 351 | 439 | 527 | 615 | 703 | 791 | 879 |
| diagonal 24 | 88 | 176 | 264 | 352 | 440 | 528 | 616 | 704 | 792 | 880 |

Tables 8-11 describe various embodiments in the systematic or randomization of the loading of the small pool or subpooled plate, row, column, and diagonal pooled DNA (FIG. 4) into an alternate Matrix Pool Plate format (FIG. 5).

TABLE 8
Example 3 screening pool design.
94 seq 5 screening pool design

| Screening pool # | Unique pools contained in each screening pool | | | | | | | | | | | |
|---|---|---|---|---|---|---|---|---|---|---|---|---|
| 1 | 1 | 95 | 189 | 283 | 377 | 471 | 565 | 659 | 753 | 847 | 301 | 827 |
| 2 | 2 | 96 | 190 | 284 | 378 | 472 | 566 | 660 | 754 | 848 | 302 | 828 |
| 3 | 3 | 97 | 191 | 285 | 379 | 473 | 567 | 661 | 755 | 849 | 303 | 829 |
| 4 | 4 | 98 | 192 | 286 | 380 | 474 | 568 | 662 | 756 | 850 | 304 | 830 |
| 5 | 5 | 99 | 193 | 287 | 381 | 475 | 569 | 663 | 757 | 851 | 377 | 831 |
| 6 | 6 | 100 | 194 | 288 | 382 | 476 | 570 | 664 | 758 | 852 | 378 | 832 |
| 7 | 7 | 101 | 195 | 289 | 383 | 477 | 571 | 665 | 759 | 853 | 379 | |
| 8 | 8 | 102 | 196 | 290 | 384 | 478 | 572 | 666 | 760 | 854 | 380 | |
| 9 | 9 | 103 | 197 | 291 | 385 | 479 | 573 | 667 | 761 | 855 | 381 | |
| 10 | 10 | 104 | 198 | 292 | 386 | 480 | 574 | 668 | 762 | 856 | 382 | |
| 11 | 11 | 105 | 199 | 293 | 387 | 481 | 575 | 669 | 763 | 857 | 383 | |
| 12 | 12 | 106 | 200 | 294 | 388 | 482 | 576 | 670 | 764 | 858 | 384 | |
| 13 | 13 | 107 | 201 | 295 | 389 | 483 | 577 | 671 | 765 | 859 | 385 | |
| 14 | 14 | 108 | 202 | 296 | 390 | 484 | 578 | 672 | 766 | 860 | 386 | |
| 15 | 15 | 109 | 203 | 297 | 391 | 485 | 579 | 673 | 767 | 861 | 387 | |
| 16 | 16 | 110 | 204 | 298 | 392 | 486 | 580 | 674 | 768 | 862 | 388 | |
| 17 | 17 | 111 | 205 | 299 | 393 | 487 | 581 | 675 | 769 | 863 | 389 | |
| 18 | 18 | 112 | 206 | 300 | 394 | 488 | 582 | 676 | 770 | 864 | 390 | |
| 19 | 19 | 113 | 207 | 301 | 395 | 489 | 583 | 677 | 771 | 865 | 391 | |
| 20 | 20 | 114 | 208 | 302 | 396 | 490 | 584 | 678 | 772 | 866 | 392 | |
| 21 | 21 | 115 | 209 | 303 | 397 | 491 | 585 | 679 | 773 | 867 | 465 | |
| 22 | 22 | 116 | 210 | 304 | 398 | 492 | 586 | 680 | 774 | 868 | 466 | |
| 23 | 23 | 117 | 211 | 305 | 399 | 493 | 587 | 681 | 775 | 869 | 467 | |
| 24 | 24 | 118 | 212 | 306 | 400 | 494 | 588 | 682 | 776 | 870 | 468 | |
| 25 | 25 | 119 | 213 | 307 | 401 | 495 | 589 | 683 | 777 | 871 | 469 | |
| 26 | 26 | 120 | 214 | 308 | 402 | 496 | 590 | 684 | 778 | 872 | 470 | |
| 27 | 27 | 121 | 215 | 309 | 403 | 497 | 591 | 685 | 779 | 873 | 471 | |
| 28 | 28 | 122 | 216 | 310 | 404 | 498 | 592 | 686 | 780 | 874 | 472 | |
| 29 | 29 | 123 | 217 | 311 | 405 | 499 | 593 | 687 | 781 | 875 | 473 | |
| 30 | 30 | 124 | 218 | 312 | 406 | 500 | 594 | 688 | 782 | 876 | 474 | |
| 31 | 31 | 125 | 219 | 313 | 407 | 501 | 595 | 689 | 783 | 877 | 475 | |
| 32 | 32 | 126 | 220 | 314 | 408 | 502 | 596 | 690 | 784 | 878 | 476 | |
| 33 | 33 | 127 | 221 | 315 | 409 | 503 | 597 | 691 | 785 | 879 | 477 | |
| 34 | 34 | 128 | 222 | 316 | 410 | 504 | 598 | 692 | 786 | 880 | 478 | |
| 35 | 35 | 129 | 223 | 317 | 411 | 505 | 599 | 693 | 787 | 25 | 479 | |
| 36 | 36 | 130 | 224 | 318 | 412 | 506 | 600 | 694 | 788 | 26 | 480 | |
| 37 | 37 | 131 | 225 | 319 | 413 | 507 | 601 | 695 | 789 | 27 | 553 | |
| 38 | 38 | 132 | 226 | 320 | 414 | 508 | 602 | 696 | 790 | 28 | 554 | |
| 39 | 39 | 133 | 227 | 321 | 415 | 509 | 603 | 697 | 791 | 29 | 555 | |
| 40 | 40 | 134 | 228 | 322 | 416 | 510 | 604 | 698 | 792 | 30 | 556 | |
| 41 | 41 | 135 | 229 | 323 | 417 | 511 | 605 | 699 | 793 | 31 | 557 | |
| 42 | 42 | 136 | 230 | 324 | 418 | 512 | 606 | 700 | 794 | 32 | 558 | |
| 43 | 43 | 137 | 231 | 325 | 419 | 513 | 607 | 701 | 795 | 33 | 559 | |
| 44 | 44 | 138 | 232 | 326 | 420 | 514 | 608 | 702 | 796 | 34 | 560 | |
| 45 | 45 | 139 | 233 | 327 | 421 | 515 | 609 | 703 | 797 | 35 | 561 | |
| 46 | 46 | 140 | 234 | 328 | 422 | 516 | 610 | 704 | 798 | 36 | 562 | |
| 47 | 47 | 141 | 235 | 329 | 423 | 517 | 611 | 705 | 799 | 37 | 563 | |
| 48 | 48 | 142 | 236 | 330 | 424 | 518 | 612 | 706 | 800 | 38 | 564 | |
| 49 | 49 | 143 | 237 | 331 | 425 | 519 | 613 | 707 | 801 | 39 | 565 | |
| 50 | 50 | 144 | 238 | 332 | 426 | 520 | 614 | 708 | 802 | 40 | 566 | |
| 51 | 51 | 145 | 239 | 333 | 427 | 521 | 615 | 709 | 803 | 113 | 567 | |
| 52 | 52 | 146 | 240 | 334 | 428 | 522 | 616 | 710 | 804 | 114 | 568 | |
| 53 | 53 | 147 | 241 | 335 | 429 | 523 | 617 | 711 | 805 | 115 | 641 | |
| 54 | 54 | 148 | 242 | 336 | 430 | 524 | 618 | 712 | 806 | 116 | 642 | |
| 55 | 55 | 149 | 243 | 337 | 431 | 525 | 619 | 713 | 807 | 117 | 643 | |
| 56 | 56 | 150 | 244 | 338 | 432 | 526 | 620 | 714 | 808 | 118 | 644 | |
| 57 | 57 | 151 | 245 | 339 | 433 | 527 | 621 | 715 | 809 | 119 | 645 | |
| 58 | 58 | 152 | 246 | 340 | 434 | 528 | 622 | 716 | 810 | 120 | 646 | |
| 59 | 59 | 153 | 247 | 341 | 435 | 529 | 623 | 717 | 811 | 121 | 647 | |
| 60 | 60 | 154 | 248 | 342 | 436 | 530 | 624 | 718 | 812 | 122 | 648 | |
| 61 | 61 | 155 | 249 | 343 | 437 | 531 | 625 | 719 | 813 | 123 | 649 | |
| 62 | 62 | 156 | 250 | 344 | 438 | 532 | 626 | 720 | 814 | 124 | 650 | |
| 63 | 63 | 157 | 251 | 345 | 439 | 533 | 627 | 721 | 815 | 125 | 651 | |
| 64 | 64 | 158 | 252 | 346 | 440 | 534 | 628 | 722 | 816 | 126 | 652 | |
| 65 | 65 | 159 | 253 | 347 | 441 | 535 | 629 | 723 | 817 | 127 | 653 | |
| 66 | 66 | 160 | 254 | 348 | 442 | 536 | 630 | 724 | 818 | 128 | 654 | |
| 67 | 67 | 161 | 255 | 349 | 443 | 537 | 631 | 725 | 819 | 201 | 655 | |
| 68 | 68 | 162 | 256 | 350 | 444 | 538 | 632 | 726 | 820 | 202 | 656 | |
| 69 | 69 | 163 | 257 | 351 | 445 | 539 | 633 | 727 | 821 | 203 | 729 | |
| 70 | 70 | 164 | 258 | 352 | 446 | 540 | 634 | 728 | 822 | 204 | 730 | |
| 71 | 71 | 165 | 259 | 353 | 447 | 541 | 635 | 729 | 823 | 205 | 731 | |
| 72 | 72 | 166 | 260 | 354 | 448 | 542 | 636 | 730 | 824 | 206 | 732 | |
| 73 | 73 | 167 | 261 | 355 | 449 | 543 | 637 | 731 | 825 | 207 | 733 | |
| 74 | 74 | 168 | 262 | 356 | 450 | 544 | 638 | 732 | 826 | 208 | 734 | |
| 75 | 75 | 169 | 263 | 357 | 451 | 545 | 639 | 733 | 827 | 209 | 735 | |
| 76 | 76 | 170 | 264 | 358 | 452 | 546 | 640 | 734 | 828 | 210 | 736 | |
| 77 | 77 | 171 | 265 | 359 | 453 | 547 | 641 | 735 | 829 | 211 | 737 | |
| 78 | 78 | 172 | 266 | 360 | 454 | 548 | 642 | 736 | 830 | 212 | 738 | |
| 79 | 79 | 173 | 267 | 361 | 455 | 549 | 643 | 737 | 831 | 213 | 739 | |
| 80 | 80 | 174 | 268 | 362 | 456 | 550 | 644 | 738 | 832 | 214 | 740 | |
| 81 | 81 | 175 | 269 | 363 | 457 | 551 | 645 | 739 | 833 | 215 | 741 | |
| 82 | 82 | 176 | 270 | 364 | 458 | 552 | 646 | 740 | 834 | 216 | 742 | |
| 83 | 83 | 177 | 271 | 365 | 459 | 553 | 647 | 741 | 835 | 289 | 743 | |
| 84 | 84 | 178 | 272 | 366 | 460 | 554 | 648 | 742 | 836 | 290 | 744 | |
| 85 | 85 | 179 | 273 | 367 | 461 | 555 | 649 | 743 | 837 | 291 | 817 | |
| 86 | 86 | 180 | 274 | 368 | 462 | 556 | 650 | 744 | 838 | 292 | 818 | |
| 87 | 87 | 181 | 275 | 369 | 463 | 557 | 651 | 745 | 839 | 293 | 819 | |
| 88 | 88 | 182 | 276 | 370 | 464 | 558 | 652 | 746 | 840 | 294 | 820 | |
| 89 | 89 | 183 | 277 | 371 | 465 | 559 | 653 | 747 | 841 | 295 | 821 | |
| 90 | 90 | 184 | 278 | 372 | 466 | 560 | 654 | 748 | 842 | 296 | 822 | |
| 91 | 91 | 185 | 279 | 373 | 467 | 561 | 655 | 749 | 843 | 297 | 823 | |
| 92 | 92 | 186 | 280 | 374 | 468 | 562 | 656 | 750 | 844 | 298 | 824 | |
| 93 | 93 | 187 | 281 | 375 | 469 | 563 | 657 | 751 | 845 | 299 | 825 | |
| 94 | 94 | 188 | 282 | 376 | 470 | 564 | 658 | 752 | 846 | 300 | 826 | |

TABLE 9
Example 4 screening pool design.
94 seq 4 & SP screening pool design

| Screening pool # | Unique pools contained in each screening pool | | | | | | | | | | | | | | | |
|---|---|---|---|---|---|---|---|---|---|---|---|---|---|---|---|---|
| 1 | 1 | 85 | 169 | 253 | 337 | 421 | 505 | 589 | 673 | 757 | 841 | | | | | |
| 2 | 2 | 86 | 170 | 254 | 338 | 422 | 506 | 590 | 674 | 758 | 842 | | | | | |
| 3 | 3 | 87 | 171 | 255 | 339 | 423 | 507 | 591 | 675 | 759 | 843 | | | | | |
| 4 | 4 | 88 | 172 | 256 | 340 | 424 | 508 | 592 | 676 | 760 | 844 | | | | | |
| 5 | 5 | 89 | 173 | 257 | 341 | 425 | 509 | 593 | 677 | 761 | 845 | | | | | |
| 6 | 6 | 90 | 174 | 258 | 342 | 426 | 510 | 594 | 678 | 762 | 846 | | | | | |
| 7 | 7 | 91 | 175 | 259 | 343 | 427 | 511 | 595 | 679 | 763 | 847 | | | | | |
| 8 | 8 | 92 | 176 | 260 | 344 | 428 | 512 | 596 | 680 | 764 | 848 | | | | | |
| 9 | 9 | 93 | 177 | 261 | 345 | 429 | 513 | 597 | 681 | 765 | 849 | | | | | |
| 10 | 10 | 94 | 178 | 262 | 346 | 430 | 514 | 598 | 682 | 766 | 850 | | | | | |
| 11 | 11 | 95 | 179 | 263 | 347 | 431 | 515 | 599 | 683 | 767 | 851 | | | | | |
| 12 | 12 | 96 | 180 | 264 | 348 | 432 | 516 | 600 | 684 | 768 | 852 | | | | | |
| 13 | 13 | 97 | 181 | 265 | 349 | 433 | 517 | 601 | 685 | 769 | 853 | | | | | |
| 14 | 14 | 98 | 182 | 266 | 350 | 434 | 518 | 602 | 686 | 770 | 854 | | | | | |
| 15 | 15 | 99 | 183 | 267 | 351 | 435 | 519 | 603 | 687 | 771 | 855 | | | | | |
| 16 | 16 | 100 | 184 | 268 | 352 | 436 | 520 | 604 | 688 | 772 | 856 | | | | | |
| 17 | 17 | 101 | 185 | 269 | 353 | 437 | 521 | 605 | 689 | 773 | 857 | | | | | |
| 18 | 18 | 102 | 186 | 270 | 354 | 438 | 522 | 606 | 690 | 774 | 858 | | | | | |
| 19 | 19 | 103 | 187 | 271 | 355 | 439 | 523 | 607 | 691 | 775 | 859 | | | | | |
| 20 | 20 | 104 | 188 | 272 | 356 | 440 | 524 | 608 | 692 | 776 | 860 | | | | | |
| 21 | 21 | 105 | 189 | 273 | 357 | 441 | 525 | 609 | 693 | 777 | 861 | | | | | |
| 22 | 22 | 106 | 190 | 274 | 358 | 442 | 526 | 610 | 694 | 778 | 862 | | | | | |
| 23 | 23 | 107 | 191 | 275 | 359 | 443 | 527 | 611 | 695 | 779 | 863 | | | | | |
| 24 | 24 | 108 | 192 | 276 | 360 | 444 | 528 | 612 | 696 | 780 | 864 | | | | | |
| 25 | 25 | 109 | 193 | 277 | 361 | 445 | 529 | 613 | 697 | 781 | 865 | | | | | |
| 26 | 26 | 110 | 194 | 278 | 362 | 446 | 530 | 614 | 698 | 782 | 866 | | | | | |
| 27 | 27 | 111 | 195 | 279 | 363 | 447 | 531 | 615 | 699 | 783 | 867 | | | | | |
| 28 | 28 | 112 | 196 | 280 | 364 | 448 | 532 | 616 | 700 | 784 | 868 | | | | | |
| 29 | 29 | 113 | 197 | 281 | 365 | 449 | 533 | 617 | 701 | 785 | 869 | | | | | |
| 30 | 30 | 114 | 198 | 282 | 366 | 450 | 534 | 618 | 702 | 786 | 870 | | | | | |
| 31 | 31 | 115 | 199 | 283 | 367 | 451 | 535 | 619 | 703 | 787 | 871 | | | | | |
| 32 | 32 | 116 | 200 | 284 | 368 | 452 | 536 | 620 | 704 | 788 | 872 | | | | | |
| 33 | 33 | 117 | 201 | 285 | 369 | 453 | 537 | 621 | 705 | 789 | 873 | | | | | |
| 34 | 34 | 118 | 202 | 286 | 370 | 454 | 538 | 622 | 706 | 790 | 874 | | | | | |
| 35 | 35 | 119 | 203 | 287 | 371 | 455 | 539 | 623 | 707 | 791 | 875 | | | | | |
| 36 | 36 | 120 | 204 | 288 | 372 | 456 | 540 | 624 | 708 | 792 | 876 | | | | | |
| 37 | 37 | 121 | 205 | 289 | 373 | 457 | 541 | 625 | 709 | 793 | 877 | | | | | |
| 38 | 38 | 122 | 206 | 290 | 374 | 458 | 542 | 626 | 710 | 794 | 878 | | | | | |
| 39 | 39 | 123 | 207 | 291 | 375 | 459 | 543 | 627 | 711 | 795 | 879 | | | | | |
| 40 | 40 | 124 | 208 | 292 | 376 | 460 | 544 | 628 | 712 | 796 | 880 | | | | | |
| 41 | 41 | 125 | 209 | 293 | 377 | 461 | 545 | 629 | 713 | 797 | | | | | | |
| 42 | 42 | 126 | 210 | 294 | 378 | 462 | 546 | 630 | 714 | 798 | | | | | | |
| 43 | 43 | 127 | 211 | 295 | 379 | 463 | 547 | 631 | 715 | 799 | | | | | | |
| 44 | 44 | 128 | 212 | 296 | 380 | 464 | 548 | 632 | 716 | 800 | | | | | | |
| 45 | 45 | 129 | 213 | 297 | 381 | 465 | 549 | 633 | 717 | 801 | | | | | | |
| 46 | 46 | 130 | 214 | 298 | 382 | 466 | 550 | 634 | 718 | 802 | | | | | | |
| 47 | 47 | 131 | 215 | 299 | 383 | 467 | 551 | 635 | 719 | 803 | | | | | | |
| 48 | 48 | 132 | 216 | 300 | 384 | 468 | 552 | 636 | 720 | 804 | | | | | | |
| 49 | 49 | 133 | 217 | 301 | 385 | 469 | 553 | 637 | 721 | 805 | | | | | | |
| 50 | 50 | 134 | 218 | 302 | 386 | 470 | 554 | 638 | 722 | 806 | | | | | | |
| 51 | 51 | 135 | 219 | 303 | 387 | 471 | 555 | 639 | 723 | 807 | | | | | | |
| 52 | 52 | 136 | 220 | 304 | 388 | 472 | 556 | 640 | 724 | 808 | | | | | | |
| 53 | 53 | 137 | 221 | 305 | 389 | 473 | 557 | 641 | 725 | 809 | | | | | | |
| 54 | 54 | 138 | 222 | 306 | 390 | 474 | 558 | 642 | 726 | 810 | | | | | | |
| 55 | 55 | 139 | 223 | 307 | 391 | 475 | 559 | 643 | 727 | 811 | | | | | | |
| 56 | 56 | 140 | 224 | 308 | 392 | 476 | 560 | 644 | 728 | 812 | | | | | | |
| 57 | 57 | 141 | 225 | 309 | 393 | 477 | 561 | 645 | 729 | 813 | | | | | | |
| 58 | 58 | 142 | 226 | 310 | 394 | 478 | 562 | 646 | 730 | 814 | | | | | | |
| 59 | 59 | 143 | 227 | 311 | 395 | 479 | 563 | 647 | 731 | 815 | | | | | | |
| 60 | 60 | 144 | 228 | 312 | 396 | 480 | 564 | 648 | 732 | 816 | | | | | | |
| 61 | 61 | 145 | 229 | 313 | 397 | 481 | 565 | 649 | 733 | 817 | | | | | | |
| 62 | 62 | 146 | 230 | 314 | 398 | 482 | 566 | 650 | 734 | 818 | | | | | | |
| 63 | 63 | 147 | 231 | 315 | 399 | 483 | 567 | 651 | 735 | 819 | | | | | | |
| 64 | 64 | 148 | 232 | 316 | 400 | 484 | 568 | 652 | 736 | 820 | | | | | | |
| 65 | 65 | 149 | 233 | 317 | 401 | 485 | 569 | 653 | 737 | 821 | | | | | | |
| 66 | 66 | 150 | 234 | 318 | 402 | 486 | 570 | 654 | 738 | 822 | | | | | | |
| 67 | 67 | 151 | 235 | 319 | 403 | 487 | 571 | 655 | 739 | 823 | | | | | | |
| 68 | 68 | 152 | 236 | 320 | 404 | 488 | 572 | 656 | 740 | 824 | | | | | | |
| 69 | 69 | 153 | 237 | 321 | 405 | 489 | 573 | 657 | 741 | 825 | | | | | | |
| 70 | 70 | 154 | 238 | 322 | 406 | 490 | 574 | 658 | 742 | 826 | | | | | | |
| 71 | 71 | 155 | 239 | 323 | 407 | 491 | 575 | 659 | 743 | 827 | | | | | | |
| 72 | 72 | 156 | 240 | 324 | 408 | 492 | 576 | 660 | 744 | 828 | | | | | | |
| 73 | 73 | 157 | 241 | 325 | 409 | 493 | 577 | 661 | 745 | 829 | | | | | | |
| 74 | 74 | 158 | 242 | 326 | 410 | 494 | 578 | 662 | 746 | 830 | | | | | | |
| 75 | 75 | 159 | 243 | 327 | 411 | 495 | 579 | 663 | 747 | 831 | | | | | | |
| 76 | 76 | 160 | 244 | 328 | 412 | 496 | 580 | 664 | 748 | 832 | | | | | | |
| 77 | 77 | 161 | 245 | 329 | 413 | 497 | 581 | 665 | 749 | 833 | | | | | | |
| 78 | 78 | 162 | 246 | 330 | 414 | 498 | 582 | 666 | 750 | 834 | | | | | | |
| 79 | 79 | 163 | 247 | 331 | 415 | 499 | 583 | 667 | 751 | 835 | | | | | | |
| 80 | 80 | 164 | 248 | 332 | 416 | 500 | 584 | 668 | 752 | 836 | | | | | | |
| 81 | 81 | 165 | 249 | 333 | 417 | 501 | 585 | 669 | 753 | 837 | | | | | | |
| 82 | 82 | 166 | 250 | 334 | 418 | 502 | 586 | 670 | 754 | 838 | | | | | | |
| 83 | 83 | 167 | 251 | 335 | 419 | 503 | 587 | 671 | 755 | 839 | | | | | | |
| 84 | 84 | 168 | 252 | 336 | 420 | 504 | 588 | 672 | 756 | 840 | | | | | | |
| 85 | 25 | 26 | 27 | 28 | 29 | 30 | 31 | 32 | 33 | 34 | 35 | 36 | 37 | 38 | 39 | 40 |
| 86 | 113 | 114 | 115 | 116 | 117 | 118 | 119 | 120 | 121 | 122 | 123 | 124 | 125 | 126 | 127 | 128 |
| 87 | 201 | 202 | 203 | 204 | 205 | 206 | 207 | 208 | 209 | 210 | 211 | 212 | 213 | 214 | 215 | 216 |
| 88 | 289 | 290 | 291 | 292 | 293 | 294 | 295 | 296 | 297 | 298 | 299 | 300 | 301 | 302 | 303 | 304 |
| 89 | 377 | 378 | 379 | 380 | 381 | 382 | 383 | 384 | 385 | 386 | 387 | 388 | 389 | 390 | 391 | 392 |
| 90 | 465 | 466 | 467 | 468 | 469 | 470 | 471 | 472 | 473 | 474 | 475 | 476 | 477 | 478 | 479 | 480 |
| 91 | 553 | 554 | 555 | 556 | 557 | 558 | 559 | 560 | 561 | 562 | 563 | 564 | 565 | 566 | 567 | 568 |
| 92 | 641 | 642 | 643 | 644 | 645 | 646 | 647 | 648 | 649 | 650 | 651 | 652 | 653 | 654 | 655 | 656 |
| 93 | 729 | 730 | 731 | 732 | 733 | 734 | 735 | 736 | 737 | 738 | 739 | 740 | 741 | 742 | 743 | 744 |
| 94 | 817 | 818 | 819 | 820 | 821 | 822 | 823 | 824 | 825 | 826 | 827 | 828 | 829 | 830 | 831 | 832 |

TABLE 10
Example 5 screening pool design.
55 seq 4 & SP screening pool design

| P# | Unique pools contained in each screening pool | | | | | | | | | | | | | | | | | | | |
|---|---|---|---|---|---|---|---|---|---|---|---|---|---|---|---|---|---|---|---|---|
| 1 | 1 | 46 | 91 | 136 | 181 | 226 | 271 | 316 | 361 | 406 | 451 | 496 | 541 | 586 | 631 | 676 | 721 | 766 | 811 | 856 |
| 2 | 2 | 47 | 92 | 137 | 182 | 227 | 272 | 317 | 362 | 407 | 452 | 497 | 542 | 587 | 632 | 677 | 722 | 767 | 812 | 857 |
| 3 | 3 | 48 | 93 | 138 | 183 | 228 | 273 | 318 | 363 | 408 | 453 | 498 | 543 | 588 | 633 | 678 | 723 | 768 | 813 | 858 |
| 4 | 4 | 49 | 94 | 139 | 184 | 229 | 274 | 319 | 364 | 409 | 454 | 499 | 544 | 589 | 634 | 679 | 724 | 769 | 814 | 859 |
| 5 | 5 | 50 | 95 | 140 | 185 | 230 | 275 | 320 | 365 | 410 | 455 | 500 | 545 | 590 | 635 | 680 | 725 | 770 | 815 | 860 |
| 6 | 6 | 51 | 96 | 141 | 186 | 231 | 276 | 321 | 366 | 411 | 456 | 501 | 546 | 591 | 636 | 681 | 726 | 771 | 816 | 861 |
| 7 | 7 | 52 | 97 | 142 | 187 | 232 | 277 | 322 | 367 | 412 | 457 | 502 | 547 | 592 | 637 | 682 | 727 | 772 | 817 | 862 |
| 8 | 8 | 53 | 98 | 143 | 188 | 233 | 278 | 323 | 368 | 413 | 458 | 503 | 548 | 593 | 638 | 683 | 728 | 773 | 818 | 863 |
| 9 | 9 | 54 | 99 | 144 | 189 | 234 | 279 | 324 | 369 | 414 | 459 | 504 | 549 | 594 | 639 | 684 | 729 | 774 | 819 | 864 |
| 10 | 10 | 55 | 100 | 145 | 190 | 235 | 280 | 325 | 370 | 415 | 460 | 505 | 550 | 595 | 640 | 685 | 730 | 775 | 820 | 865 |
| 11 | 11 | 56 | 101 | 146 | 191 | 236 | 281 | 326 | 371 | 416 | 461 | 506 | 551 | 596 | 641 | 686 | 731 | 776 | 821 | 866 |
| 12 | 12 | 57 | 102 | 147 | 192 | 237 | 282 | 327 | 372 | 417 | 462 | 507 | 552 | 597 | 642 | 687 | 732 | 777 | 822 | 867 |
| 13 | 13 | 58 | 103 | 148 | 193 | 238 | 283 | 328 | 373 | 418 | 463 | 508 | 553 | 598 | 643 | 688 | 733 | 778 | 823 | 868 |
| 14 | 14 | 59 | 104 | 149 | 194 | 239 | 284 | 329 | 374 | 419 | 464 | 509 | 554 | 599 | 644 | 689 | 734 | 779 | 824 | 869 |
| 15 | 15 | 60 | 105 | 150 | 195 | 240 | 285 | 330 | 375 | 420 | 465 | 510 | 555 | 600 | 645 | 690 | 735 | 780 | 825 | 870 |
| 16 | 16 | 61 | 106 | 151 | 196 | 241 | 286 | 331 | 376 | 421 | 466 | 511 | 556 | 601 | 646 | 691 | 736 | 781 | 826 | 871 |
| 17 | 17 | 62 | 107 | 152 | 197 | 242 | 287 | 332 | 377 | 422 | 467 | 512 | 557 | 602 | 647 | 692 | 737 | 782 | 827 | 872 |
| 18 | 18 | 63 | 108 | 153 | 198 | 243 | 288 | 333 | 378 | 423 | 468 | 513 | 558 | 603 | 648 | 693 | 738 | 783 | 828 | 873 |
| 19 | 19 | 64 | 109 | 154 | 199 | 244 | 289 | 334 | 379 | 424 | 469 | 514 | 559 | 604 | 649 | 694 | 739 | 784 | 829 | 874 |
| 20 | 20 | 65 | 110 | 155 | 200 | 245 | 290 | 335 | 380 | 425 | 470 | 515 | 560 | 605 | 650 | 695 | 740 | 785 | 830 | 875 |
| 21 | 21 | 66 | 111 | 156 | 201 | 246 | 291 | 336 | 381 | 426 | 471 | 516 | 561 | 606 | 651 | 696 | 741 | 786 | 831 | 876 |
| 22 | 22 | 67 | 112 | 157 | 202 | 247 | 292 | 337 | 382 | 427 | 472 | 517 | 562 | 607 | 652 | 697 | 742 | 787 | 832 | 877 |
| 23 | 23 | 68 | 113 | 158 | 203 | 248 | 293 | 338 | 383 | 428 | 473 | 518 | 563 | 608 | 653 | 698 | 743 | 788 | 833 | 878 |
| 24 | 24 | 69 | 114 | 159 | 204 | 249 | 294 | 339 | 384 | 429 | 474 | 519 | 564 | 609 | 654 | 699 | 744 | 789 | 834 | 879 |
| 25 | 25 | 70 | 115 | 160 | 205 | 250 | 295 | 340 | 385 | 430 | 475 | 520 | 565 | 610 | 655 | 700 | 745 | 790 | 835 | 880 |
| 26 | 26 | 71 | 116 | 161 | 206 | 251 | 296 | 341 | 386 | 431 | 476 | 521 | 566 | 611 | 656 | 701 | 746 | 791 | 836 | |
| 27 | 27 | 72 | 117 | 162 | 207 | 252 | 297 | 342 | 387 | 432 | 477 | 522 | 567 | 612 | 657 | 702 | 747 | 792 | 837 | |
| 28 | 28 | 73 | 118 | 163 | 208 | 253 | 298 | 343 | 388 | 433 | 478 | 523 | 568 | 613 | 658 | 703 | 748 | 793 | 838 | |
| 29 | 29 | 74 | 119 | 164 | 209 | 254 | 299 | 344 | 389 | 434 | 479 | 524 | 569 | 614 | 659 | 704 | 749 | 794 | 839 | |
| 30 | 30 | 75 | 120 | 165 | 210 | 255 | 300 | 345 | 390 | 435 | 480 | 525 | 570 | 615 | 660 | 705 | 750 | 795 | 840 | |
| 31 | 31 | 76 | 121 | 166 | 211 | 256 | 301 | 346 | 391 | 436 | 481 | 526 | 571 | 616 | 661 | 706 | 751 | 796 | 841 | |
| 32 | 32 | 77 | 122 | 167 | 212 | 257 | 302 | 347 | 392 | 437 | 482 | 527 | 572 | 617 | 662 | 707 | 752 | 797 | 842 | |
| 33 | 33 | 78 | 123 | 168 | 213 | 258 | 303 | 348 | 393 | 438 | 483 | 528 | 573 | 618 | 663 | 708 | 753 | 798 | 843 | |
| 34 | 34 | 79 | 124 | 169 | 214 | 259 | 304 | 349 | 394 | 439 | 484 | 529 | 574 | 619 | 664 | 709 | 754 | 799 | 844 | |
| 35 | 35 | 80 | 125 | 170 | 215 | 260 | 305 | 350 | 395 | 440 | 485 | 530 | 575 | 620 | 665 | 710 | 755 | 800 | 845 | |
| 36 | 36 | 81 | 126 | 171 | 216 | 261 | 306 | 351 | 396 | 441 | 486 | 531 | 576 | 621 | 666 | 711 | 756 | 801 | 846 | |
| 37 | 37 | 82 | 127 | 172 | 217 | 262 | 307 | 352 | 397 | 442 | 487 | 532 | 577 | 622 | 667 | 712 | 757 | 802 | 847 | |
| 38 | 38 | 83 | 128 | 173 | 218 | 263 | 308 | 353 | 398 | 443 | 488 | 533 | 578 | 623 | 668 | 713 | 758 | 803 | 848 | |
| 39 | 39 | 84 | 129 | 174 | 219 | 264 | 309 | 354 | 399 | 444 | 489 | 534 | 579 | 624 | 669 | 714 | 759 | 804 | 849 | |
| 40 | 40 | 85 | 130 | 175 | 220 | 265 | 310 | 355 | 400 | 445 | 490 | 535 | 580 | 625 | 670 | 715 | 760 | 805 | 850 | |
| 41 | 41 | 86 | 131 | 176 | 221 | 266 | 311 | 356 | 401 | 446 | 491 | 536 | 581 | 626 | 671 | 716 | 761 | 806 | 851 | |
| 42 | 42 | 87 | 132 | 177 | 222 | 267 | 312 | 357 | 402 | 447 | 492 | 537 | 582 | 627 | 672 | 717 | 762 | 807 | 852 | |
| 43 | 43 | 88 | 133 | 178 | 223 | 268 | 313 | 358 | 403 | 448 | 493 | 538 | 583 | 628 | 673 | 718 | 763 | 808 | 853 | |
| 44 | 44 | 89 | 134 | 179 | 224 | 269 | 314 | 359 | 404 | 449 | 494 | 539 | 584 | 629 | 674 | 719 | 764 | 809 | 854 | |
| 45 | 45 | 90 | 135 | 180 | 225 | 270 | 315 | 360 | 405 | 450 | 495 | 540 | 585 | 630 | 675 | 720 | 765 | 810 | 855 | |
| 46 | 25 | 26 | 27 | 28 | 29 | 30 | 31 | 32 | 33 | 34 | 35 | 36 | 37 | 38 | 39 | 40 | | | | |
| 47 | 113 | 114 | 115 | 116 | 117 | 118 | 119 | 120 | 121 | 122 | 123 | 124 | 125 | 126 | 127 | 128 | | | | |
| 48 | 201 | 202 | 203 | 204 | 205 | 206 | 207 | 208 | 209 | 210 | 211 | 212 | 213 | 214 | 215 | 216 | | | | |
| 49 | 289 | 290 | 291 | 292 | 293 | 294 | 295 | 296 | 297 | 298 | 299 | 300 | 301 | 302 | 303 | 304 | | | | |
| 50 | 377 | 378 | 379 | 380 | 381 | 382 | 383 | 384 | 385 | 386 | 387 | 388 | 389 | 390 | 391 | 392 | | | | |
| 51 | 465 | 466 | 467 | 468 | 469 | 470 | 471 | 472 | 473 | 474 | 475 | 476 | 477 | 478 | 479 | 480 | | | | |
| 52 | 553 | 554 | 555 | 556 | 557 | 558 | 559 | 560 | 561 | 562 | 563 | 564 | 565 | 566 | 567 | 568 | | | | |
| 53 | 641 | 642 | 643 | 644 | 645 | 646 | 647 | 648 | 649 | 650 | 651 | 652 | 653 | 654 | 655 | 656 | | | | |
| 54 | 729 | 730 | 731 | 732 | 733 | 734 | 735 | 736 | 737 | 738 | 739 | 740 | 741 | 742 | 743 | 744 | | | | |
| 55 | 817 | 818 | 819 | 820 | 821 | 822 | 823 | 824 | 825 | 826 | 827 | 828 | 829 | 830 | 831 | 832 | | | | |

TABLE 11
Example 5 screening pool design.
45 seq 5 screening pool design

| [symbol] ng pool | | | | | | | | | | | | | |
|---|---|---|---|---|---|---|---|---|---|---|---|---|---|
| # | Unique pools contained in each screening pool | | | | | | | | | | | | |
| 1 | 1 | 46 | 91 | 136 | 181 | 226 | 271 | 316 | 361 | 406 | 451 | 496 | 541 |
| 2 | 2 | 47 | 92 | 137 | 182 | 227 | 272 | 317 | 362 | 407 | 452 | 497 | 542 |
| 3 | 3 | 48 | 93 | 138 | 183 | 228 | 273 | 318 | 363 | 408 | 453 | 498 | 543 |
| 4 | 4 | 49 | 94 | 139 | 184 | 229 | 274 | 319 | 364 | 409 | 454 | 499 | 544 |
| 5 | 5 | 50 | 95 | 140 | 185 | 230 | 275 | 320 | 365 | 410 | 455 | 500 | 545 |
| 6 | 6 | 51 | 96 | 141 | 186 | 231 | 276 | 321 | 366 | 411 | 456 | 501 | 546 |
| 7 | 7 | 52 | 97 | 142 | 187 | 232 | 277 | 322 | 367 | 412 | 457 | 502 | 547 |
| 8 | 8 | 53 | 98 | 143 | 188 | 233 | 278 | 323 | 368 | 413 | 458 | 503 | 548 |
| 9 | 9 | 54 | 99 | 144 | 189 | 234 | 279 | 324 | 369 | 414 | 459 | 504 | 549 |
| 10 | 10 | 55 | 100 | 145 | 190 | 235 | 280 | 325 | 370 | 415 | 460 | 505 | 550 |
| 11 | 11 | 56 | 101 | 146 | 191 | 236 | 281 | 326 | 371 | 416 | 461 | 506 | 551 |
| 12 | 12 | 57 | 102 | 147 | 192 | 237 | 282 | 327 | 372 | 417 | 462 | 507 | 552 |
| 13 | 13 | 58 | 103 | 148 | 193 | 238 | 283 | 328 | 373 | 418 | 463 | 508 | 553 |
| 14 | 14 | 59 | 104 | 149 | 194 | 239 | 284 | 329 | 374 | 419 | 464 | 509 | 554 |
| 15 | 15 | 60 | 105 | 150 | 195 | 240 | 285 | 330 | 375 | 420 | 465 | 510 | 555 |
| 16 | 16 | 61 | 106 | 151 | 196 | 241 | 286 | 331 | 376 | 421 | 466 | 511 | 556 |
| 17 | 17 | 62 | 107 | 152 | 197 | 242 | 287 | 332 | 377 | 422 | 467 | 512 | 557 |
| 18 | 18 | 63 | 108 | 153 | 198 | 243 | 288 | 333 | 378 | 423 | 468 | 513 | 558 |
| 19 | 19 | 64 | 109 | 154 | 199 | 244 | 289 | 334 | 379 | 424 | 469 | 514 | 559 |
| 20 | 20 | 65 | 110 | 155 | 200 | 245 | 290 | 335 | 380 | 425 | 470 | 515 | 560 |
| 21 | 21 | 66 | 111 | 156 | 201 | 246 | 291 | 336 | 381 | 426 | 471 | 516 | 561 |
| 22 | 22 | 67 | 112 | 157 | 202 | 247 | 292 | 337 | 382 | 427 | 472 | 517 | 562 |
| 23 | 23 | 68 | 113 | 158 | 203 | 248 | 293 | 338 | 383 | 428 | 473 | 518 | 563 |
| 24 | 24 | 69 | 114 | 159 | 204 | 249 | 294 | 339 | 384 | 429 | 474 | 519 | 564 |
| 25 | 25 | 70 | 115 | 160 | 205 | 250 | 295 | 340 | 385 | 430 | 475 | 520 | 565 |
| 26 | 26 | 71 | 116 | 161 | 206 | 251 | 296 | 341 | 386 | 431 | 476 | 521 | 566 |
| 27 | 27 | 72 | 117 | 162 | 207 | 252 | 297 | 342 | 387 | 432 | 477 | 522 | 567 |
| 28 | 28 | 73 | 118 | 163 | 208 | 253 | 298 | 343 | 388 | 433 | 478 | 523 | 568 |
| 29 | 29 | 74 | 119 | 164 | 209 | 254 | 299 | 344 | 389 | 434 | 479 | 524 | 569 |
| 30 | 30 | 75 | 120 | 165 | 210 | 255 | 300 | 345 | 390 | 435 | 480 | 525 | 570 |
| 31 | 31 | 76 | 121 | 166 | 211 | 256 | 301 | 346 | 391 | 436 | 481 | 526 | 571 |
| 32 | 32 | 77 | 122 | 167 | 212 | 257 | 302 | 347 | 392 | 437 | 482 | 527 | 572 |
| 33 | 33 | 78 | 123 | 168 | 213 | 258 | 303 | 348 | 393 | 438 | 483 | 528 | 573 |
| 34 | 34 | 79 | 124 | 169 | 214 | 259 | 304 | 349 | 394 | 439 | 484 | 529 | 574 |
| 35 | 35 | 80 | 125 | 170 | 215 | 260 | 305 | 350 | 395 | 440 | 485 | 530 | 575 |
| 36 | 36 | 81 | 126 | 171 | 216 | 261 | 306 | 351 | 396 | 441 | 486 | 531 | 576 |
| 37 | 37 | 82 | 127 | 172 | 217 | 262 | 307 | 352 | 397 | 442 | 487 | 532 | 577 |
| 38 | 38 | 83 | 128 | 173 | 218 | 263 | 308 | 353 | 398 | 443 | 488 | 533 | 578 |
| 39 | 39 | 84 | 129 | 174 | 219 | 264 | 309 | 354 | 399 | 444 | 489 | 534 | 579 |
| 40 | 40 | 85 | 130 | 175 | 220 | 265 | 310 | 355 | 400 | 445 | 490 | 535 | 580 |
| 41 | 41 | 86 | 131 | 176 | 221 | 266 | 311 | 356 | 401 | 446 | 491 | 536 | 581 |
| 42 | 42 | 87 | 132 | 177 | 222 | 267 | 312 | 357 | 402 | 447 | 492 | 537 | 582 |
| 43 | 43 | 88 | 133 | 178 | 223 | 268 | 313 | 358 | 403 | 448 | 493 | 538 | 583 |
| 44 | 44 | 89 | 134 | 179 | 224 | 269 | 314 | 359 | 404 | 449 | 494 | 539 | 584 |
| 45 | 45 | 90 | 135 | 180 | 225 | 270 | 315 | 360 | 405 | 450 | 495 | 540 | 585 |

| [symbol] ng pool | | | | | | | | | | | | |
|---|---|---|---|---|---|---|---|---|---|---|---|---|
| # | Unique pools contained in each screening pool | | | | | | | | | | | |
| 1 | 586 | 631 | 676 | 721 | 766 | 811 | 856 | 21 | 194 | 367 | 540 | 713 |
| 2 | 587 | 632 | 677 | 722 | 767 | 812 | 857 | 22 | 195 | 368 | 541 | 714 |
| 3 | 588 | 633 | 678 | 723 | 768 | 813 | 858 | 23 | 196 | 369 | 542 | 715 |
| 4 | 589 | 634 | 679 | 724 | 769 | 814 | 859 | 24 | 197 | 370 | 543 | 716 |
| 5 | 590 | 635 | 680 | 725 | 770 | 815 | 860 | 89 | 198 | 371 | 544 | 717 |
| 6 | 591 | 636 | 681 | 726 | 771 | 816 | 861 | 90 | 199 | 372 | 545 | 718 |
| 7 | 592 | 637 | 682 | 727 | 772 | 817 | 862 | 91 | 200 | 373 | 546 | 719 |
| 8 | 593 | 638 | 683 | 728 | 773 | 818 | 863 | 92 | 265 | 374 | 547 | 720 |
| 9 | 594 | 639 | 684 | 729 | 774 | 819 | 864 | 93 | 266 | 375 | 548 | 721 |
| 10 | 595 | 640 | 685 | 730 | 775 | 820 | 865 | 94 | 267 | 376 | 549 | 722 |
| 11 | 596 | 641 | 686 | 731 | 776 | 821 | 866 | 95 | 268 | 441 | 550 | 723 |
| 12 | 597 | 642 | 687 | 732 | 777 | 822 | 867 | 96 | 269 | 442 | 551 | 724 |
| 13 | 598 | 643 | 688 | 733 | 778 | 823 | 868 | 97 | 270 | 443 | 552 | 725 |
| 14 | 599 | 644 | 689 | 734 | 779 | 824 | 869 | 98 | 271 | 444 | 617 | 726 |
| 15 | 600 | 645 | 690 | 735 | 780 | 825 | 870 | 99 | 272 | 445 | 618 | 727 |
| 16 | 601 | 646 | 691 | 736 | 781 | 826 | 871 | 100 | 273 | 446 | 619 | 728 |
| 17 | 602 | 647 | 692 | 737 | 782 | 827 | 872 | 101 | 274 | 447 | 620 | 793 |
| 18 | 603 | 648 | 693 | 738 | 783 | 828 | 873 | 102 | 275 | 448 | 621 | 794 |
| 19 | 604 | 649 | 694 | 739 | 784 | 829 | 874 | 103 | 276 | 449 | 622 | 795 |
| 20 | 605 | 650 | 695 | 740 | 785 | 830 | 875 | 104 | 277 | 450 | 623 | 796 |
| 21 | 606 | 651 | 696 | 741 | 786 | 831 | 876 | 105 | 278 | 451 | 624 | 797 |
| 22 | 607 | 652 | 697 | 742 | 787 | 832 | 877 | 106 | 279 | 452 | 625 | 798 |
| 23 | 608 | 653 | 698 | 743 | 788 | 833 | 878 | 107 | 280 | 453 | 626 | 799 |
| 24 | 609 | 654 | 699 | 744 | 789 | 834 | 879 | 108 | 281 | 454 | 627 | 800 |
| 25 | 610 | 655 | 700 | 745 | 790 | 835 | 880 | 109 | 282 | 455 | 628 | 801 |
| 26 | 611 | 656 | 701 | 746 | 791 | 836 | 1 | 110 | 283 | 456 | 629 | 802 |
| 27 | 612 | 657 | 702 | 747 | 792 | 837 | 2 | 111 | 284 | 457 | 630 | 803 |
| 28 | 613 | 658 | 703 | 748 | 793 | 838 | 3 | 112 | 285 | 458 | 631 | 804 |
| 29 | 614 | 659 | 704 | 749 | 794 | 839 | 4 | 177 | 286 | 459 | 632 | 805 |
| 30 | 615 | 660 | 705 | 750 | 795 | 840 | 5 | 178 | 287 | 460 | 633 | 806 |
| 31 | 616 | 661 | 706 | 751 | 796 | 841 | 6 | 179 | 288 | 461 | 634 | 807 |
| 32 | 617 | 662 | 707 | 752 | 797 | 842 | 7 | 180 | 353 | 462 | 635 | 808 |
| 33 | 618 | 663 | 708 | 753 | 798 | 843 | 8 | 181 | 354 | 463 | 636 | 809 |
| 34 | 619 | 664 | 709 | 754 | 799 | 844 | 9 | 182 | 355 | 464 | 637 | 810 |
| 35 | 620 | 665 | 710 | 755 | 800 | 845 | 10 | 183 | 356 | 529 | 638 | 811 |
| 36 | 621 | 666 | 711 | 756 | 801 | 846 | 11 | 184 | 357 | 530 | 639 | 812 |
| 37 | 622 | 667 | 712 | 757 | 802 | 847 | 12 | 185 | 358 | 531 | 640 | 813 |
| 38 | 623 | 668 | 713 | 758 | 803 | 848 | 13 | 186 | 359 | 532 | 705 | 814 |
| 39 | 624 | 669 | 714 | 759 | 804 | 849 | 14 | 187 | 360 | 533 | 706 | 815 |
| 40 | 625 | 670 | 715 | 760 | 805 | 850 | 15 | 188 | 361 | 534 | 707 | 816 |
| 41 | 626 | 671 | 716 | 761 | 806 | 851 | 16 | 189 | 362 | 535 | 708 | |
| 42 | 627 | 672 | 717 | 762 | 807 | 852 | 17 | 190 | 363 | 536 | 709 | |
| 43 | 628 | 673 | 718 | 763 | 808 | 853 | 18 | 191 | 364 | 537 | 710 | |
| 44 | 629 | 674 | 719 | 764 | 809 | 854 | 19 | 192 | 365 | 538 | 711 | |
| 45 | 630 | 675 | 720 | 765 | 810 | 855 | 20 | 193 | 366 | 539 | 712 | |

[symbol]

indicates data missing or illegible when filed

Tables 8, 9, 10 and 11 show four of the many specific repooling designs that were tested to demonstrate the utility of this patent.

Tables 12-16 are data showing multiple embodiments of various randomization schemes for pooling a quantification of data loaded into the Matrix Pool Plate (FIG. 5).

TABLE 12
Summary of various screening pool design unique clone identification.
Pooling Summary with each clone contained in 4 to 8 unique pools.

| | | Total | | | | |
|---|---|---|---|---|---|---|
| | | possible | | | | |
| Screening | | instances | Unique clone identification | | | |
| Pool size | design | of clone | maximum | −1 | −2 | −3 |
| 30 | rnd 4 | 4 | 86.4% | 13.0% | 0.6% | 0.0% |
| 30 | seq 4 | 4 | 83.7% | 16.0% | 0.3% | 0.0% |
| 45 | rnd 4 | 4 | 88.0% | 11.6% | 0.3% | 0.0% |
| 45 | seq 5 | 5 | 85.1% | 14.3% | 0.6% | 0.0% |
| 55 | seq 4 & SP | 5 | 91.2% | 8.5% | 0.2% | 0.0% |
| 61 | rnd 4 | 4 | 91.9% | 8.0% | 0.1% | 0.0% |
| 61 | seq 4 | 4 | 95.1% | 4.9% | 0.0% | 0.0% |
| 89 | seq & step 8 | 8 | 100.0% | 0.0% | 0.0% | 0.0% |
| 89 | seq 8 | 8 | 100.0% | 0.0% | 0.0% | 0.0% |
| 89 | seq & rnd 8 | 8 | 100.0% | 0.0% | 0.0% | 0.0% |
| 89 | seq 6 | 6 | 100.0% | 0.0% | 0.0% | 0.0% |
| 89 | step 5 | 5 | 100.0% | 0.0% | 0.0% | 0.0% |
| 89 | seq 5 | 5 | 100.0% | 0.0% | 0.0% | 0.0% |
| 89 | rnd 4 | 4 | 94.6% | 5.3% | 0.1% | 0.0% |
| 89 | seq 4 | 4 | 100.0% | 0.0% | 0.0% | 0.0% |
| 94 | seq 4 & SP | 5 | 99.3% | 0.7% | 0.0% | 0.0% |
| 94 | seq 5 | 5 | 96.8% | 3.2% | 0.0% | 0.0% |

TABLE 13
Summary of various screening pool design unique clone identification.
Possibilities to find one random clone

| Screening | | False positives found during identification | | | | | | | |
|---|---|---|---|---|---|---|---|---|---|
| Pool size | design | <9 | 9-7 | 7-5 | 5-3 | 2 | 1 | 0 | −1 |
| 30 | rnd 4 | | | | | | | | |
| 30 | seq 4 | | | | | | | | |
| 45 | rnd 4 | | | | | | | | |
| 45 | seq 5 | 0% | 0% | 0% | 4% | 3% | 46% | 48% | 4% |
| 55 | seq 4 & SP | 0% | 0% | 0% | 0% | 0% | 43% | 49% | 8% |
| 61 | rnd 4 | | | | | | | | |
| 61 | seq 4 | | | | | | | | |
| 89 | seq & step 8 | 0% | 0% | 0% | 0% | 0% | 0% | 100% | |
| 89 | seq 8 | 0% | 0% | 0% | 0% | 0% | 0% | 100% | |
| 89 | seq & rnd 8 | 0% | 0% | 0% | 0% | 0% | 0% | 100% | |
| 89 | seq 6 | 0% | 0% | 0% | 0% | 0% | 0% | 100% | |
| 89 | step 5 | 0% | 0% | 0% | 0% | 0% | 0% | 100% | |
| 89 | seq 5 | 0% | 0% | 0% | 0% | 0% | 0% | 100% | |
| 89 | rnd 4 | 0% | 0% | 0% | 0% | 0% | 0% | 95% | 5% |
| 89 | seq 4 | 0% | 0% | 0% | 0% | 0% | 0% | 100% | |
| 94 | seq 4 & SP | 0% | 0% | 0% | 0% | 0% | 0% | 100% | |
| 94 | seq 5 | 0% | 0% | 0% | 0% | 0% | 0% | 96% | 4% |

TABLE 14
Summary of various screening pool designs searching
for one unique clone identification.
Possibilities to find one random clone

| Screening | | False positives found during identification | | | | | | | |
|---|---|---|---|---|---|---|---|---|---|
| Pool size | design | <9 | 9-7 | 7-5 | 5-3 | 2 | 1 | 0 | −1 |
| 30 | rnd 4 | | | | | | | | |
| 30 | seq 4 | | | | | | | | |
| 45 | rnd 4 | | | | | | | | |
| 45 | seq 5 | 0% | 0% | 0% | 4% | 3% | 46% | 48% | 4% |
| 55 | seq 4 & SP | 0% | 0% | 0% | 0% | 0% | 43% | 49% | 8% |
| 61 | rnd 4 | | | | | | | | |
| 61 | seq 4 | | | | | | | | |
| 89 | seq & step 8 | 0% | 0% | 0% | 0% | 0% | 0% | 100% | |
| 89 | seq 8 | 0% | 0% | 0% | 0% | 0% | 0% | 100% | |
| 89 | seq & rnd 8 | 0% | 0% | 0% | 0% | 0% | 0% | 100% | |
| 89 | seq 6 | 0% | 0% | 0% | 0% | 0% | 0% | 100% | |
| 89 | step 5 | 0% | 0% | 0% | 0% | 0% | 0% | 100% | |
| 89 | seq 5 | 0% | 0% | 0% | 0% | 0% | 0% | 100% | |
| 89 | rnd 4 | 0% | 0% | 0% | 0% | 0% | 0% | 95% | 5% |
| 89 | seq 4 | 0% | 0% | 0% | 0% | 0% | 0% | 100% | |
| 94 | seq 4 & SP | 0% | 0% | 0% | 0% | 0% | 0% | 100% | |
| 94 | seq 5 | 0% | 0% | 0% | 0% | 0% | 0% | 96% | 4% |

TABLE 15
Summary of various screening pool designs searching
for two unique clone identifications.
Possibilities to find random sets of 2 unique but similar marker containing clones

| Screening | | False positives found during identification | | | | | | | |
|---|---|---|---|---|---|---|---|---|---|
| pool | design | 6+ | 5 | 4 | 3 | 2 | 1 | 0 | −1 |
| 30 | rnd 4 | | | | | | | | |
| 30 | seq 4 | | | | | | | | |
| 45 | rnd 4 | | | | | | | | |
| 45 | seq 5 | 39% | 12% | 11% | 11% | 8% | 10% | 7% | 1% |
| 55 | seq 4 & SP | 15% | 10% | 14% | 24% | 10% | 16% | 8% | 1% |
| 61 | rnd 4 | | | | | | | | |
| 61 | seq 4 | | | | | | | | |
| 89 | seq & step 8 | 4% | 4% | 4% | 6% | 22% | 33% | 21% | 0% |
| 89 | seq 8 | | | | | | | | |
| 89 | seq & rnd 8 | 0% | 0% | 0% | 0% | 2% | 5% | 61% | 29% |
| 89 | seq 6 | | | | | | | | |
| 89 | step 5 | 1% | 1% | 3% | 11% | 14% | 41% | 29% | 0% |
| 89 | seq 5 | 0% | 0% | 1% | 1% | 7% | 22% | 63% | 6% |
| 89 | rnd 4 | 0% | 0% | 1% | 4% | 10% | 20% | 64% | 1% |
| 89 | seq 4 | 1% | 1% | 4% | 5% | 17% | 38% | 34% | 0% |
| 94 | seq 4 & SP | 0% | 0% | 0% | 0% | 5% | 11% | 84% | 0% |
| 94 | seq 5 | 0% | 0% | 0% | 1% | 7% | 20% | 69% | 3% |

TABLE 16
Summary of various screening pool designs searching for three unique clone identifications.
Possibilities to find random sets of 3 unique but similar marker containing clones

| Screening | | False positives found during identification | | | | | | | | | | | | | | | | | |
|---|---|---|---|---|---|---|---|---|---|---|---|---|---|---|---|---|---|---|---|
| Pool size | design | >15 | 14 | 13 | 12 | 11 | 10 | 9 | 8 | 7 | 6 | 5 | 4 | 3 | 2 | 1 | 0 | −1 | −2 |
| 30 | rnd 4 | | | | | | | | | | | | | | | | | | |
| 30 | seq 4 | | | | | | | | | | | | | | | | | | |
| 45 | rnd 4 | | | | | | | | | | | | | | | | | | |
| 45 | seq 5 | 89% | 0% | 1% | 1% | 0% | 2% | 0% | 2% | 0% | 2% | 0% | 0% | 1% | 0% | 0% | 0% | 0% | 0% |
| 55 | seq 4 & SP | 61% | 8% | 3% | 2% | 2% | 5% | 7% | 1% | 0% | 3% | 3% | 0% | 1% | 1% | 0% | 0% | 0% | 0% |
| 61 | rnd 4 | | | | | | | | | | | | | | | | | | |
| 61 | seq 4 | | | | | | | | | | | | | | | | | | |
| 89 | seq & step 8 | 20% | 4% | 3% | 4% | 3% | 6% | 9% | 10% | 13% | 8% | 9% | 6% | 3% | 1% | 0% | 1% | 0% | 0% |
| 89 | seq 8 | 17% | 4% | 3% | 4% | 14% | 6% | 7% | 6% | 10% | 14% | 8% | 10% | 5% | 0% | 1% | 0% | 1% | 0% |
| 89 | seq & rnd 8 | 2% | 2% | 5% | 5% | 3% | 2% | 11% | 9% | 13% | 14% | 13% | 10% | 6% | 2% | 2% | 1% | 0% | 0% |
| 89 | seq 6 | 0% | 0% | 0% | 0% | 0% | 0% | 0% | 0% | 0% | 2% | 3% | 2% | 7% | 19% | 20% | 27% | 17% | 1% |
| 89 | step 5 | 2% | 2% | 5% | 5% | 3% | 2% | 11% | 9% | 13% | 14% | 13% | 10% | 6% | 2% | 2% | 1% | 0% | 0% |
| 89 | seq 5 | 0% | 0% | 0% | 0% | 0% | 0% | 0% | 1% | 5% | 3% | 7% | 14% | 14% | 16% | 28% | 9% | 3% | 0% |
| 89 | rnd 4 | 0% | 0% | 0% | 0% | 0% | 0% | 0% | 5% | 5% | 9% | 8% | 13% | 17% | 17% | 19% | 7% | 0% | 0% |
| 89 | seq 4 | 2% | 2% | 1% | 3% | 2% | 2% | 10% | 17% | 14% | 19% | 8% | 10% | 8% | 1% | 0% | 1% | 0% | 0% |
| 94 | seq 4 & SP | 0% | 0% | 0% | 0% | 0% | 0% | 0% | 1% | 0% | 1% | 8% | 14% | 14% | 24% | 32% | 8% | 2% | 0% |
| 94 | seq 5 | 0% | 0% | 0% | 0% | 0% | 0% | 0% | 0% | 2% | 2% | 0% | 6% | 15% | 37% | 26% | 11% | 1% | 0% |

Tables 13, 14, 15 and 16 show data collected from various pooling designs.

In order to facilitate quick and accurate analysis of user screening data, we have developed a computer program, which identifies the appropriate plate and well position of all potential positive clones. The results will be processed with error correction algorithms to enhance the reliability of the results and compensate for false negative data and false positive data (inherent in many screening technologies like PCR). The results will be displayed as probability scores indicating the likelihood of the resulting plate and well position being correct.

While the invention has been described with reference to more than one embodiment, it is to be clearly understood by those skilled in the art that the invention is not limited to those embodiments. The general concept involves separating the large library set into multiple superpools and then making one, or more than one, set(s) of matrix pools formed by re-pooling a subset of the unique pools into screening pools that will be screened. Each unique pool can be placed in 0, 1, or more than one screening pools, depending on the redundancy of identification required.

Some of the embodiments contemplated herein pertain to construction of pooled biological material, such as DNA, RNA, proteins and the like, that are able to be screened by a wide variety of methods, such as sequencing, PCR (Polymerase Chain Reaction), DNA/DNA hybridization, DNA/RNA hybridization, RNA/RNA hybridization, single strand DNA probing, protein/protein hybridization, and a wide variety of additional methods. Construction of pools and superpools for screening as described herein differs from known methods in that the biological material set is systematically divided into a variety of smaller subsets, which are then re-pooled to make the final screening pools. This pooled material can be from individual samples or a population of samples. In order to reduce the analysis time, materials, and expense, the pooling of high resolution small pools in a matrix allows for a lower number of user experiments to have higher resolution (as if the researcher had analyzed the complete set of small pools).

In one embodiment, a substance identification method includes using a collection of segregated substances placed in respective wells of a plurality of collection plates physically or logically arranged in a stack. The wells are arranged in a plurality of rows and a plurality of columns and individual substances have a unique coordinate locating a well position defined by a plate identifier, a row identifier, and a column identifier. The method includes combining the substances into four or more intermediate subpools in respective wells of a subpool plate. The four or more intermediate subpools are of at least one type of intermediate subpool. One to four of the types of subpool are selected from the group consisting of a plate pool from wells having a common plate identifier, a row pool from wells having a common row identifier, a column pool from wells having a common column identifier, and a diagonal pool from wells having column and/or row identifiers per plate that are offset with respect to column and/or row identifiers per plate of any adjacent plate in the stack.

The four or more intermediate subpools are repooled into a number of final screening pools less than the four or more intermediate subpools. The final screening pools are placed in respective wells of a matrix pool plate based on a repooling design providing the subpooled substances in at least three different final screening pools. The method includes screening the final screening pools and identifying the presence of an item of interest associated with a substance. By using the repooling design, the coordinate is determined locating the well position in the collection for the substance associated with the item of interest.

By way of example, the subpooled substances may be different. However, as discussed above, some redundancy of substances may exist in a collection. The collection may be a portion of a BAC library, or may be an entire BAC library. Other possibilities for the substances may be selected from the group consisting of biological material clones or fragments, expressed proteins, purified proteins, materials exhibiting biological activity, chemicals expressed in biological processes, and combinations thereof. The item of interest may be selected from the group consisting of a nucleotide sequence in a biological material clone or fragment, a biological activity exhibited by a material, a chemical composition, and combinations thereof. Biological activity for proteins could include binding to specific chemicals, receptor sites, or antibodies, regulating proteins for transcription or translation, DNA binding proteins that turn other genes on or off, etc. Accordingly, the substances may be biological material clones including genomic DNA clones and the item of interest may be a DNA nucleotide sequence in a genomic clone DNA insert.

When the substances are biological material clones and the item of interest is a nucleotide sequence, the method may further include culturing the collection of clones, producing respective individual clone cultures, and forming the intermediate subpools using the individual clone cultures. Biological material fragments may be isolated from the four or more intermediate subpools and stored in a stable form prior to the repooling.

The at least one type of intermediate subpool may include four types of subpool including the plate pool, the row pool, the column pool, and the diagonal pool. The offset column and/or row identifiers of the diagonal pool may be offset by one column and/or row with respect to adjacent plates and might not be repeated in the diagonal pool for any other plate. The screening may be selected from the group consisting of sequencing, PCR probing, DNA to DNA hybridization probing, RNA to DNA probing, protein to protein probing, antibody to protein probing, DNA to protein probing, RNA to protein probing, chemical compound to protein probing, ligand to protein probing, and combinations or modifications thereof.

The repooling design may provide the subpooled substances in four to eight of the final screening pools to establish the benefits enumerated above. When the collection is a three-dimensional array, the combining of substances may use four types of intermediate subpools to provide four-dimensions of intermediate subpools. A sum of the plurality of plates, the plurality of rows, and the plurality of columns may be less than a number of the intermediate subpools sufficient to identify the well position of any substance in the array. Then, the repooling design may produce a number of final screening pools sufficient to identify the well position of any substance in the array, even though the number of final screening pools is less than the sum.

It follows, in one embodiment, that a method for identifying an individual genomic clone DNA insert from a collection of genomic DNA clones includes the following features. The individual genomic DNA clones are arrayed in a plurality of respective wells of a plurality of collection plates comprised of rows and columns. Individual genomic DNA clones have a specific coordinate locating a well position defined by three or four pools chosen from the group consisting of a plate pool, a row pool, a column pool, and a diagonal pool. The pools are in a hierarchical structure that is composed of a plate identifier, a row identifier, and a column identifier.

The method includes culturing the collection of genomic DNA clones and constructing at least four intermediate subpools by combining individual genomic DNA clone cultures in accordance with the hierarchical structure. Genomic DNA clone DNA is isolated from the at least four intermediate subpools and stored in a stable form. The at least four intermediate subpools are repooled into a number of Final Screening Pools based on a chosen repooling design. The subpooled individual genomic DNA clone DNA is in at least 4 Final Screening Pools and no more than 8 Final Screening Pools. The number of Final Screening Pools is screened for a DNA sequence of interest, determining the specific coordinate using the chosen repooling design and identifying the well position of the DNA sequence of interest.

Additional embodiments involve using a still further pooling design. In one embodiment, a substance identification method includes using a collection of segregated substances placed in respective wells physically or logically arranged in a two-dimensional array. The wells are arranged in a plurality of rows and a number of columns that is at least 1.5 times the plurality of rows. Individual substances have a unique coordinate locating a well position defined by a row identifier and a column identifier.

The method includes combining the substances into a number of screening pools in respective wells of a matrix pool plate. A plurality of individual screening pools include substances from wells having a row identifier in common with one other well. Pools are based on a pooling design that provides the pooled substances in two different screening pools. The method also includes screening the screening pools and identifying the presence of an item of interest associated with a substance. The pooling design is used to determine the coordinate locating the well position in the collection for the substance associated with the item of interest.

By way of example, further features described above for other embodiments may also be used in the present embodiment, if pertinent and supportive thereof. The number of columns may be at least two times the plurality of rows, or at least two times the plurality of rows plus one. The number of screening pools may match the number of columns. Given that the array may be logically arranged, instead of physically arranged, the array may reside on a plurality of microtiter well plates and at least some of the screening pools may extend across a plurality of the plates. The pooling design may provide screening pools from contiguous wells or, instead, one or more of the wells in a pool may be non-contiguous. In the context of the present document, contiguous wells are those that are adjacent in the sense that they are not separated from one another by another well, whether in a horizontal, vertical, or diagonal direction. A number of the screening pools sufficient to identify the well position of any substance in the array may be less than a sum of the plurality of rows and the number of columns.

The pooling design may reduce the two-dimensional array to a one-dimensional array. The one-dimensional array may include pseudo-column pools from a plurality of wells having a common column identifier and another equal number of wells having a row identifier in common with the plurality of wells. Instead, the one-dimensional array may include bi-diagonal pools from a plurality of wells that do not have row or column identifiers in common and another equal number of wells having a row identifier in common with the plurality of wells. The other number of wells in the pseudo-column pools or the bi-diagonal pools might not have row or column identifiers in common.

The pooling design may instead reduce a part of the two-dimensional array to a one-dimensional array. The screening pools from another part of the two-dimensional array may form screening pools in a second dimension, such as a row dimension. The number of screening pools may be at least the number of wells of the matrix pool plate, as shown Table 17 below, that corresponds to a total number of wells in the pooling design. The combination function formula below Table 17 used to calculate the contents of Table 17 may be used to determine any number of screening pools not shown in Table 17.

When the substances are biological material clones and the item of interest is a nucleotide sequence, the method may include culturing the collection of clones. The method may further include producing respective individual clone cultures, forming the screening pools using the individual clone cultures, and isolating biological material fragments from the screening pools. The isolated fragments may be stored in a stable form prior to the screening.

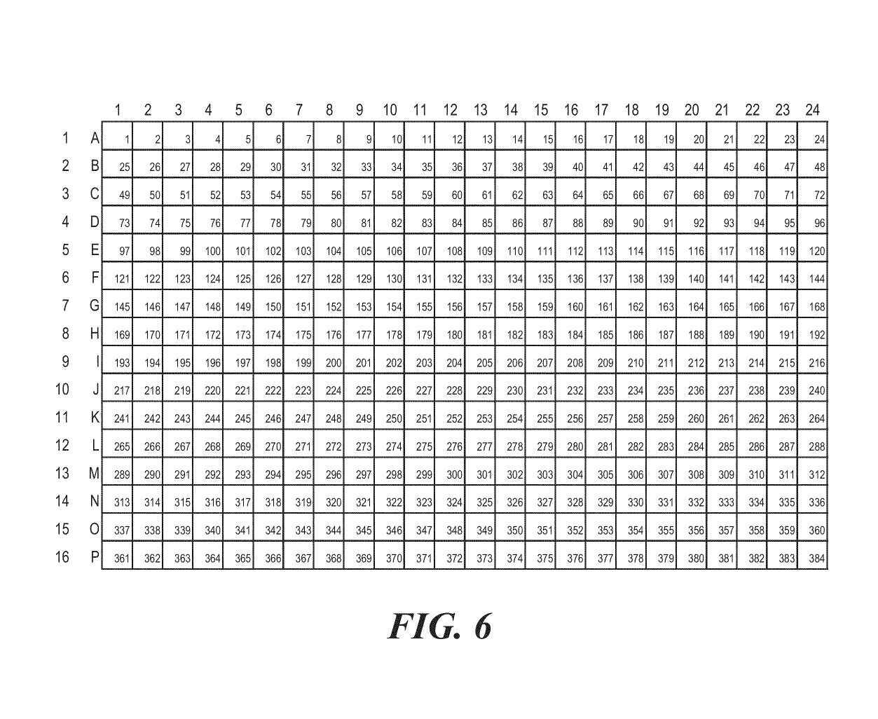

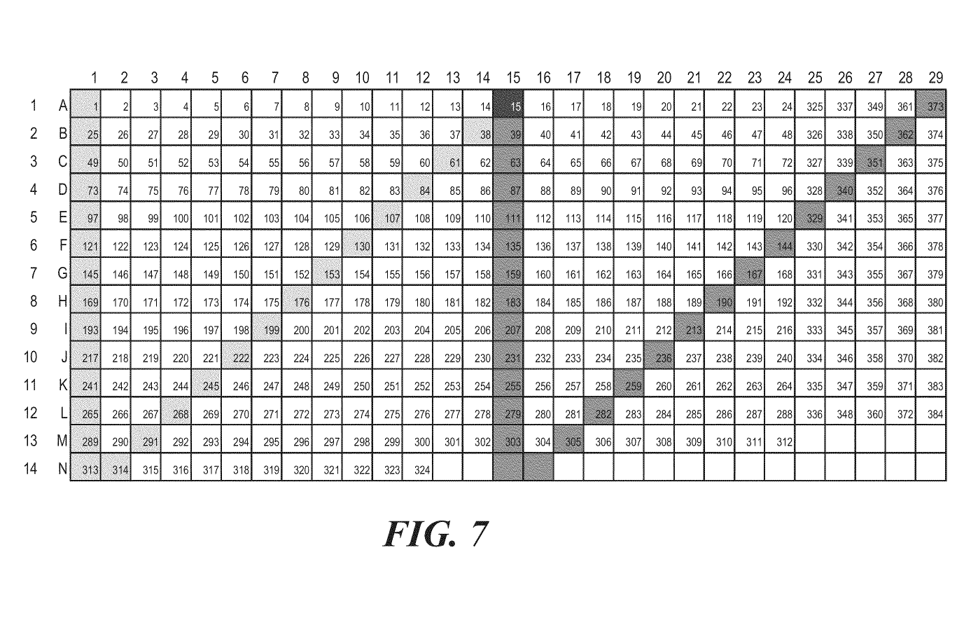

FIGS. 6 and 7 demonstrate one example of a substance identification method implementing some of the features of the immediately preceding embodiment. FIG. 6 shows a grid representing wells of a 384-well plate with 24 columns and 16 rows. Accordingly, the number of columns is 1.5 times the number of rows. Although the physical arrangement of a 384-well plate could be used, benefits exist to using a logical arrangement for the array placed in the same 384-well plate as in FIG. 6, but with the number of columns at least two times the number of rows, or two times the number plus one.

FIG. 7 shows a grid representing 384 wells, which may be located in the 384-well plate of FIG. 6. Note that individual well numbers are shown in FIG. 6 sequentially numbered from left to right and from top to bottom. Well numbers in FIG. 6 represent the same wells with a corresponding number shown in FIG. 7. The wells in FIG. 7 are sequentially numbered the same as in FIG. 6 from left to right out to column 24 and from top to bottom down to row M. However, wells 325 to 336 appearing in row N between columns 13 and 24 of FIG. 6 become column 25 for the logical arrangement of FIG. 7. Wells 337 to 384 are similarly shifted in the logical arrangement to form columns 26-29 of FIG. 7.

With the logical arrangement of FIG. 7, the substances from the wells may be combined into 29 screening pools, matching the number of columns in FIG. 7. Individual screening pools include substances from wells having a row identifier in common with one other well based on a pooling design that provides the pooled substances in two different screening pools. As one example, FIG. 7 shows 28 lightly shaded wells, each of which have a row identifier in common with one other lightly shaded well. Such wells include wells in column 1 and a diagonal extending upward from well 314 in row N, column 2 to well 15 in row A, column 15.

Any of the wells in columns 2-29 of FIG. 7 could be selected instead of the lightly shaded diagonal of wells to provide wells with a row identifier in common with the row identifier of wells in column 1. The selection could even be random, as long as a given well was not selected for more than two screening pools. However, selecting contiguous wells as often as possible for the screening pool facilitates efficiency in robotic movements of devices collecting substances from the wells.

Hence, a pseudo-column pool may be created that includes column 1 and “extends” the column through the two-dimensional array in FIG. 7 to include additional wells that have a row identifier in common with the wells of column 1. The FIG. 7 pooling design could be described as including wells having a common column identifier (column 1). The other equal number of wells in FIG. 7 has a row identifier in common with the plurality of wells but does not have a row or column identifier in common among the other equal number of wells. That is, none of the wells in the diagonal have a row or column identifier in common with one another.

A second screening pool may have the same form as the lightly shaded wells in FIG. 7 but shift to the right one position. Thereby, screening pool 2 includes the wells of column 2 and a diagonal extending upward from well 315 at row N, column 2 to well 16 at row A, column 16. It will be appreciated that both screening pool 1 and screening pool 2 include well 314. Indeed, well 314 is the only “intersection” of those two screening pools. The selection of screening pools may continue, shifting over one position for each pool until all 384 wells are included in screening pools.

FIG. 7 also shows 26 darkly shaded wells that may be included in screening pool 15 in like manner. Notably, FIG. 7 shows an intersection of the lightly shaded screening pool 1 and the darkly shaded screening pool 15 at well 15 at row A, column 15. The intersection occurs where the diagonal portion of one screening pool overlaps with the column portion of another screening pool. In other words, the intersection is the well in common with the two screening pools.

The intersection shown in FIG. 7 occurs at the top of the diagonal and column. The intersection first mentioned above for well 314 occurs at the bottom of the diagonal and column. Other intersections occur between the two throughout the logical two-dimensional array in FIG. 7 so that the pooled substances of every well appear in two different screening pools. When screening occurs, it should identify the presence of an item of interest in each of two different screening pools. The intersection of the two pools can be used to determine the coordinate locating the well containing the substance, such as a biological material, associated with the item of interest, such as a nucleotide sequence.

For consistency in the FIG. 7 pattern for selecting wells for a screening pool, the diagonal simply shifts over one position from that shown for each column shifted over from column 1. As a result, it will be appreciated that column 15 extends downward, theoretically, to a well located one position below well 303. Similarly, the corresponding diagonal extends from a well one position below well 304 at row N, column 16 upward to well 373 at row A, column 29. Wells at the positions below wells 303 and 304 would not be included in the screening pool since they do not exist in the plate having the 384 wells designated in FIG. 7. An analogous selection design is used for columns 25-29 even though row M and row N are both missing from such columns. Since the logical array of FIG. 7 has 406 positions, the positions of 406 wells could be uniquely identified. They could include 384 wells of one plate plus 22 wells of another plate, 406 wells on a larger plate, or some other configuration.

Screening pool 16 includes column 16 and the diagonal that begins with well 306 at row M, column 18 and extends up to well 374 at row B, column 29. However, the diagonal does not end at column 29 and wraps to column 1 as though it were present next to column 29 to include well 1 at row A, column 1. Thus, well 1 is the intersection of screening pool 16 and screening pool 1.

If column 29 were absent from the logical array in FIG. 7, wells 373-384 could be positioned elsewhere, such as columns 13-24 of row N. The diagonal of screening pool 15 that otherwise would have ended at well 373 would instead wrap to column 1 and include well 1. Accordingly, with the absence of column 29 from the logical array, screening pool 1 and screening pool 15 would intersect twice. One intersection is at well 1 and the other is at well 15. Consequently, a nonspecific deconvolution would exist and it would be impossible to determine, without further testing, whether the item of interest is in well 1 or well 15. The positions of substances in only 378 of the 384 wells could be uniquely identified.

It follows then, that a number of columns that is 1.5 to 2 times the number of rows may introduce uncertainty that could warrant an additional test to clarify the ambiguity. Some level of nonspecific deconvolution may be acceptable depending on factors such as the ultimate purpose of the data not requiring absolute deconvolution. For example, with oversampling, a desired region of interest or substance may well be deconvoluted even though every specific individual or substance might not be absolutely deconvoluted.

Column 30 may be added to the array so that the number of columns is greater than two times the number of rows plus one. One way to add column 30 and still keep 14 rows includes duplicating wells 301 to 312 of row M (or other wells) in column 30. Of course, the duplication would create redundant testing. Another way to add column 30 is to move wells 313 to 324 from row N to a new column 30. No duplication would exist, but the total number of tests to resolve the location of all 384 substances would increase from 29 to 30.

It is also worth noting that the 29 screening pools (29 columns) designed as in FIG. 7 are capable of uniquely identifying the location of an additional 22 substances (total 406=14×29). The 384 wells were selected for the example merely because known well plates often contain 384 wells. If known row and column pools were instead used to screen a 384-well plate, it would take 40 tests (=16+24) instead of the 29 described by the embodiments herein.

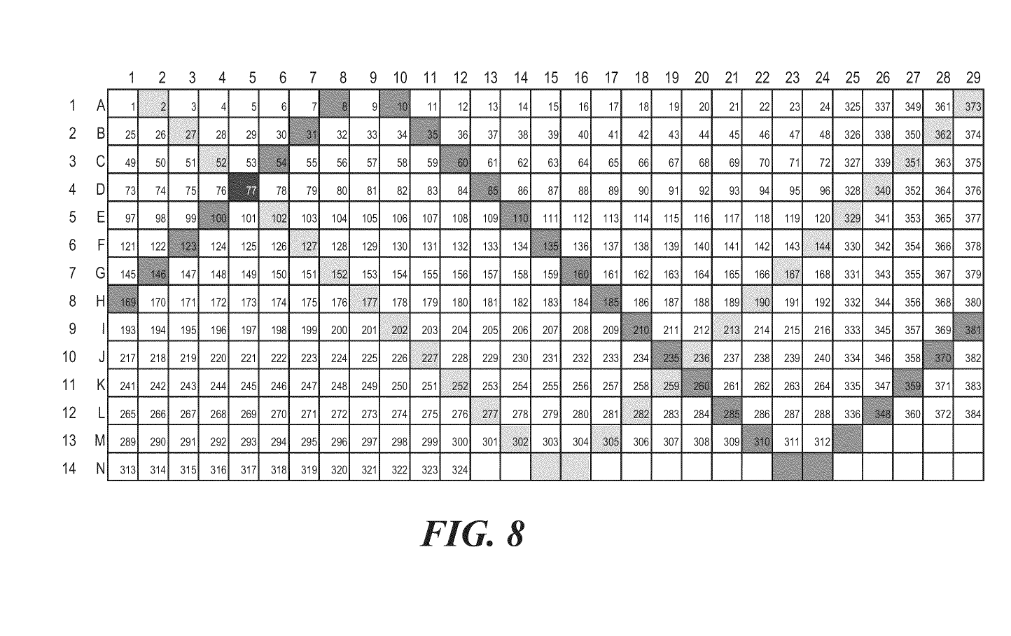

Another variation in the embodiments includes the one-dimensional array having bi-diagonal pools from a plurality of wells that do not have row or column identifiers in common and another equal number of wells having a row identifier in common with the plurality of wells. Like the pseudo-column pools embodiment, such an embodiment also fits within the general criteria of screening pools including wells having a row identifier in common with one other well based on a pooling design that provides the pooled substances in two different screening pools. FIG. 8 shows a grid with 29 columns and 384 wells as for FIG. 7, but includes bi-diagonal pools as described above. The embodiment of FIG. 8 further specifies that the other equal number of wells do not have row or column identifiers in common among themselves.

The considerations for pseudo-column pools discussed above also apply to the bi-diagonal pools of FIG. 8. Although the application of the bi-diagonal pools is easily understood from their graphical depiction, other pooling designs are conceivable that provide some of the same benefits and fit within the general criteria for reducing a two-dimensional array to a one-dimensional array. Other benefits possibly unique to the pseudo-column pool and bi-diagonal pool embodiment include efficiency in robotic manipulation due to using contiguous wells for each pool. Reduction in robotic or manual manipulation during testing or sequencing reduces the significant costs of DNA sequencing library construction.

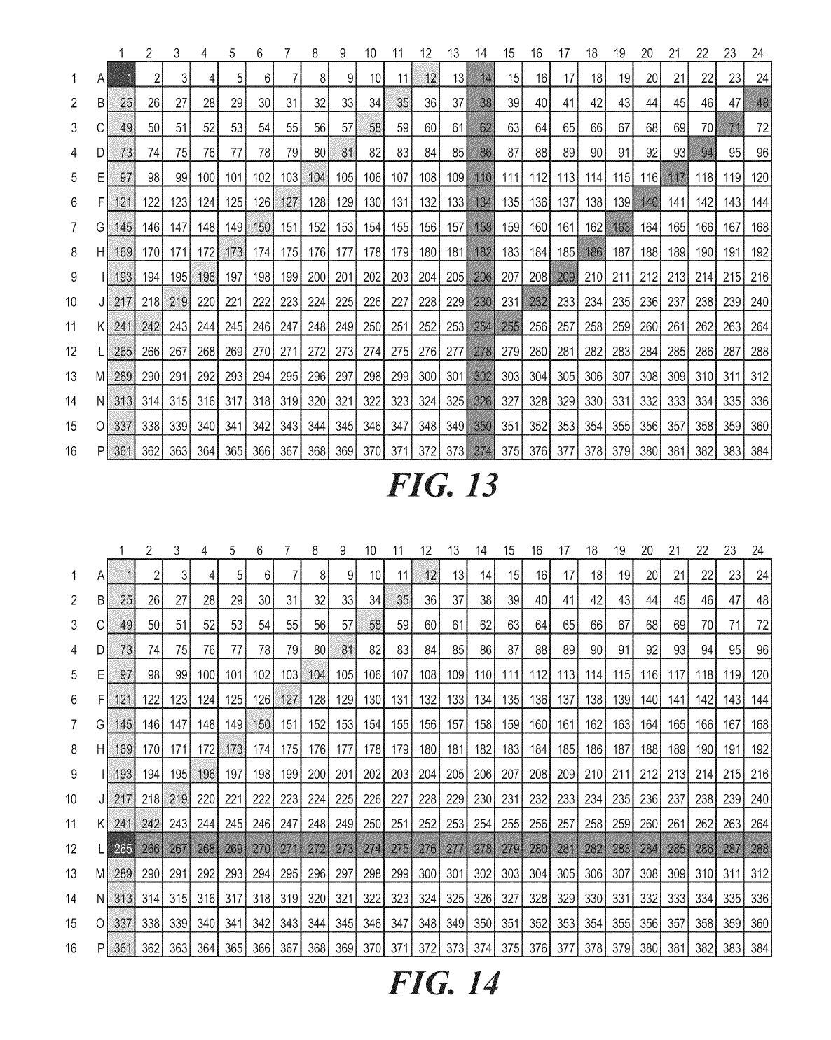

FIGS. 13 and 14 show one example of another pooling design that includes similar benefits to those of the pseudo-column pool and bi-diagonal pool embodiments. The additional embodiment reduces a part of the two-dimensional array to a one-dimensional array and the screening pools from another part of the two-dimensional array form screening pools in a second dimension. However, the number of screening pools is at least two times the number of rows plus one. By forming one or more pools, such as row pools, to include the remainder of wells in the array, well positions for substances might still be uniquely identified in the reduced number of screening pools enabled by complete reduction to one-dimension. The row pools still have a row identifier in common with one other well based on a pooling design that provides the pooled substances in two different screening pools.

Lightly shaded screening pool 1 (column 1) in FIG. 13 includes both column and diagonal portions as for FIG. 7, but the diagonal is shorter in comparison. The part of screening pool 1 in rows L to P does not have another equal number of wells providing a row identifier in common therewith. Accordingly, no intersections occur in rows L to P for screening pools 1-24 designed as shown in FIG. 13. Even so, intersections occur in rows A to K as for the embodiment of FIG. 7. One such intersection is shown in FIG. 13 between screening pools 1 and 14 (column 14) at well 1.

However, row pools L to P, designed as shown for row pool L in FIG. 14, intersect with the part of screening pools 1-24 in rows L to P that does not have another equal number of wells in screening pools 1-24 with a row identifier in common. For example, screening pool 1 and row pool L intersect at well 265. Notably, FIGS. 13 and 14 show a pooling design that provides the pooled substances in two different screening pools and allows determining the coordinates locating the well positions for all 384 wells of the array. The pools total 29 with screening pools 1-24 and row pools L to P, which is still much less than known row/column pooling using 40 pools (=16+24).

Per Table 17 below, using 24 matrix wells could be used to determine unique locations for 276 wells when there are 24 screening pools with two screening pools in each combination. Known row and column pooling for five rows and 24 columns can determine unique locations for 120 (=5×24) wells. In total, 396 well locations can be identified with the FIGS. 13 and 14 embodiment with 29 pools compared to 406 wells for the FIG. 7 or 8 embodiments including 29 screening pools with two screening pools in each combination (see Table 17).

Conceivably, a three-dimensional array may also be reduced to a one-dimensional array using the principles described herein. For example, an additional diagonal or column might be added to the pools for FIGS. 7 and 8 or other two-dimensional arrays herein. The additional diagonal or column of a screening pool may extend up out of the page, so to speak, into a third dimension. The theoretical increase in the number of individuals that can be uniquely identified when a three-dimensional array is reduced to a one-dimensional array is shown in Table 17 compared to the number of unique individuals identified for a two-dimensional array.

TABLE 17
2-D and 3-D Pools

| Matrix | | 384-well | | 384-well |
|---|---|---|---|---|
| Wells | 2-D Wells | plates | 3-D Wells | plates |
| 1 | | | | |
| 2 | 1 | 0.00 | | |
| 3 | 3 | 0.01 | 1 | 0.00 |
| 4 | 6 | 0.02 | 4 | 0.01 |
| 5 | 10 | 0.03 | 10 | 0.03 |
| 6 | 15 | 0.04 | 20 | 0.05 |
| 7 | 21 | 0.05 | 35 | 0.09 |
| 8 | 28 | 0.07 | 56 | 0.15 |
| 9 | 36 | 0.09 | 84 | 0.22 |
| 10 | 45 | 0.12 | 120 | 0.31 |
| . . . | . . . | . . . | . . . | . . . |
| 24 | 276 | 0.72 | 2,024 | 5.27 |
| . . . | . . . | . . . | . . . | . . . |
| 27 | 351 | 0.91 | 2,925 | 7.62 |
| 28 | 378 | 0.98 | 3,276 | 8.53 |
| 29 | 406 | 1.06 | 3,654 | 9.52 |
| 30 | 435 | 1.13 | 4,060 | 10.57 |
| 31 | 465 | 1.21 | 4,495 | 11.71 |
| . . . | . . . | . . . | . . . | . . . |
| 39 | 741 | 1.93 | 9,139 | 23.80 |
| 40 | 780 | 2.03 | 9,880 | 25.73 |
| 41 | 820 | 2.14 | 10,660 | 27.76 |
| . . . | . . . | . . . | . . . | . . . |
| 48 | 1,128 | 2.94 | 17,296 | 45.04 |
| 49 | 1,176 | 3.06 | 18,424 | 47.98 |
| 50 | 1,225 | 3.19 | 19,600 | 51.04 |
| 51 | 1,275 | 3.32 | 20,825 | 54.23 |
| 52 | 1,326 | 3.45 | 22,100 | 57.55 |
| 53 | 1,378 | 3.59 | 23,426 | 61.01 |
| 54 | 1,431 | 3.73 | 24,804 | 64.59 |
| 55 | 1,485 | 3.87 | 26,235 | 68.32 |
| 56 | 1,540 | 4.01 | 27,720 | 72.19 |
| . . . | . . . | . . . | . . . | . . . |
| 73 | 2,628 | 6.84 | 62,196 | 161.97 |
| 74 | 2,701 | 7.03 | 64,824 | 168.81 |
| 75 | 2,775 | 7.23 | 67,525 | 175.85 |
| 76 | 2,850 | 7.42 | 70,300 | 183.07 |
| 77 | 2,926 | 7.62 | 73,150 | 190.49 |
| 78 | 3,003 | 7.82 | 76,076 | 198.11 |
| 79 | 3,081 | 8.02 | 79,079 | 205.93 |
| 80 | 3,160 | 8.23 | 82,160 | 213.96 |
| . . . | . . . | . . . | . . . | . . . |
| 88 | 3,828 | 9.97 | 109,736 | 285.77 |
| 89 | 3,916 | 10.20 | 113,564 | 295.74 |
| 90 | 4,005 | 10.43 | 117,480 | 305.94 |
| 91 | 4,095 | 10.66 | 121,485 | 316.37 |
| 92 | 4,186 | 10.90 | 125,580 | 327.03 |
| 93 | 4,278 | 11.14 | 129,766 | 337.93 |
| 94 | 4,371 | 11.38 | 134,044 | 349.07 |
| 95 | 4,465 | 11.63 | 138,415 | 360.46 |
| 96 | 4,560 | 11.88 | 142,880 | 372.08 |
| 97 | 4,656 | 12.13 | 147,440 | 383.96 |

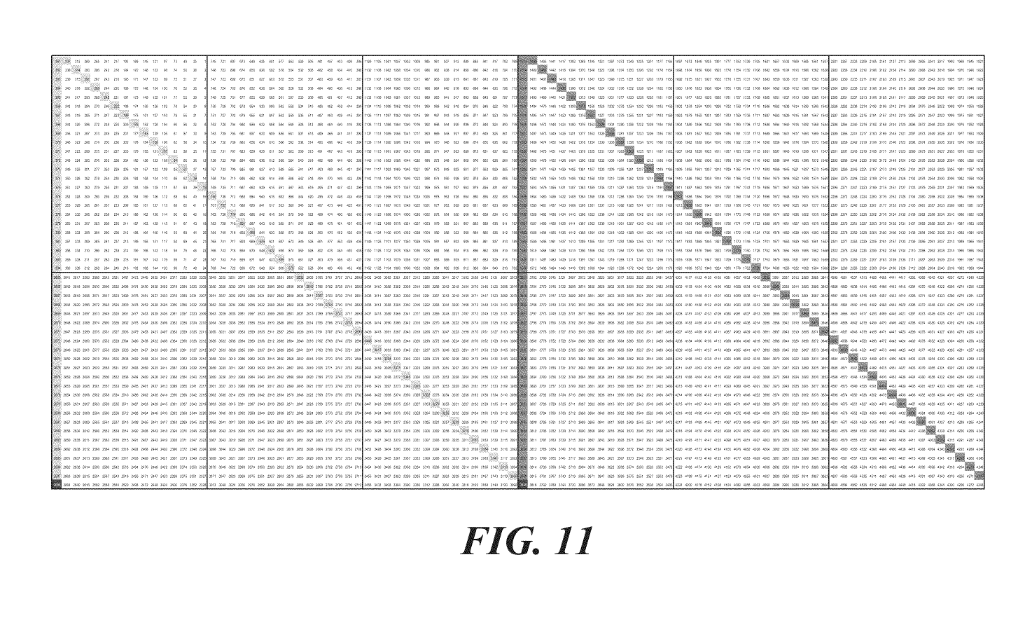

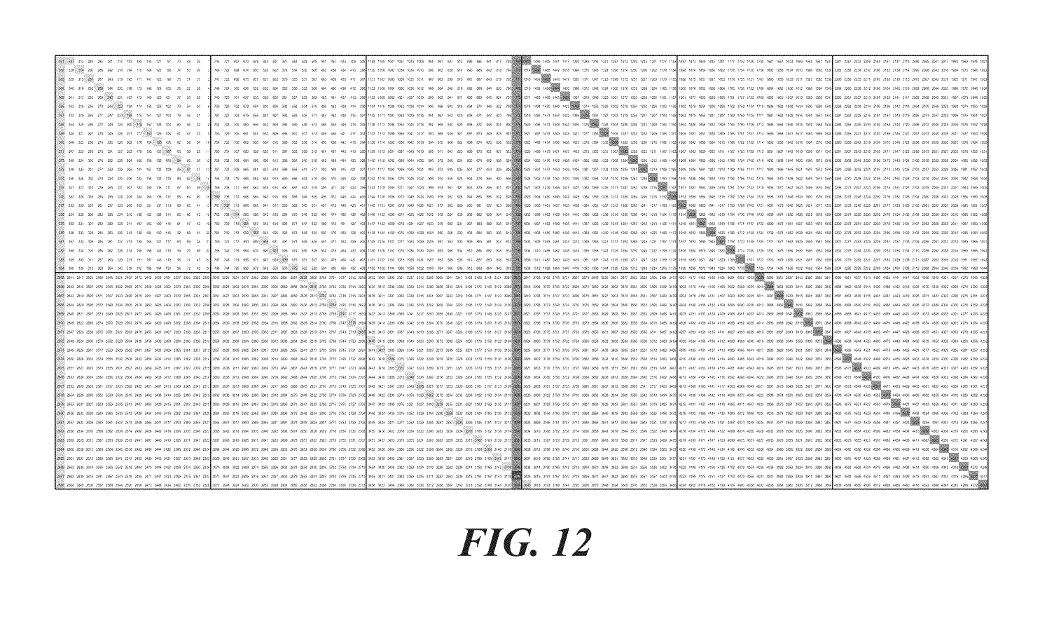

For example, with 28 matrix wells available, 378 wells combined into 28 two-dimensional screening pools could be uniquely located. The wells could all be on one 384-well plate. Also, with 28 matrix wells available, 3,276 wells combined into 28 three-dimensional screening pools could be uniquely located. The wells could all be on nine 384-well plates. It will be further appreciated that up to 4,560 wells from twelve 384-well plates could be combined into 96 two-dimensional screening pools and placed in a single 96-well plate. The full 4,608 wells on twelve 384-well plates would use 97 matrix wells, as further shown below with respect to FIGS. 11 and 12. Nevertheless, astoundingly 142,880 wells from three hundred seventy three 384-well plates could be combined into just 96 three-dimensional screening pools and their locations uniquely identified.

Values in the 2-D Wells and 3-D Wells columns are calculated using the following formula for a combination function:

$$( \begin{matrix}n \\ k\end{matrix} ) = \frac{\text{?}}{\text{?}} = \frac{n}{k \vert ( n - k ) \vert}$$

$$where \text{:}$$

$$\text{?} = \frac{n \vert}{( n - k ) \vert}$$

$$\text{?} \text{indicates text missing or illegible when filed}$$

The function returns the number of combinations where n=a given number of items (matrix wells) and k=a number of items in each combination (2=2-D Wells; 3=3-D Wells).

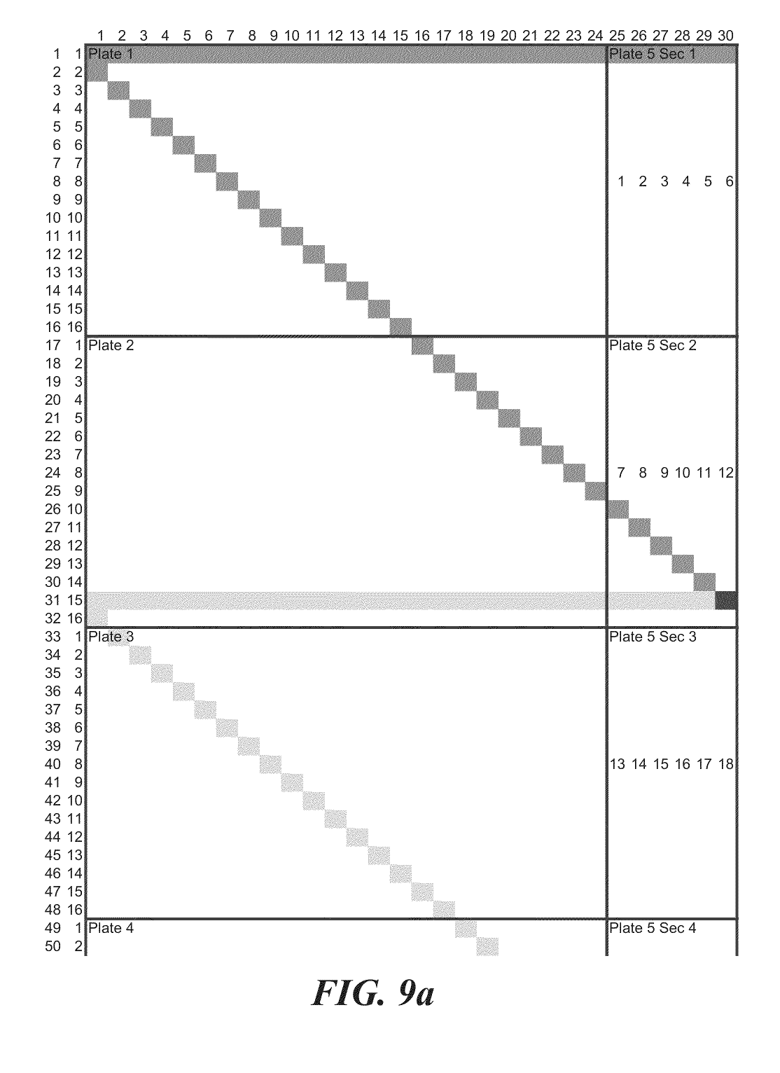

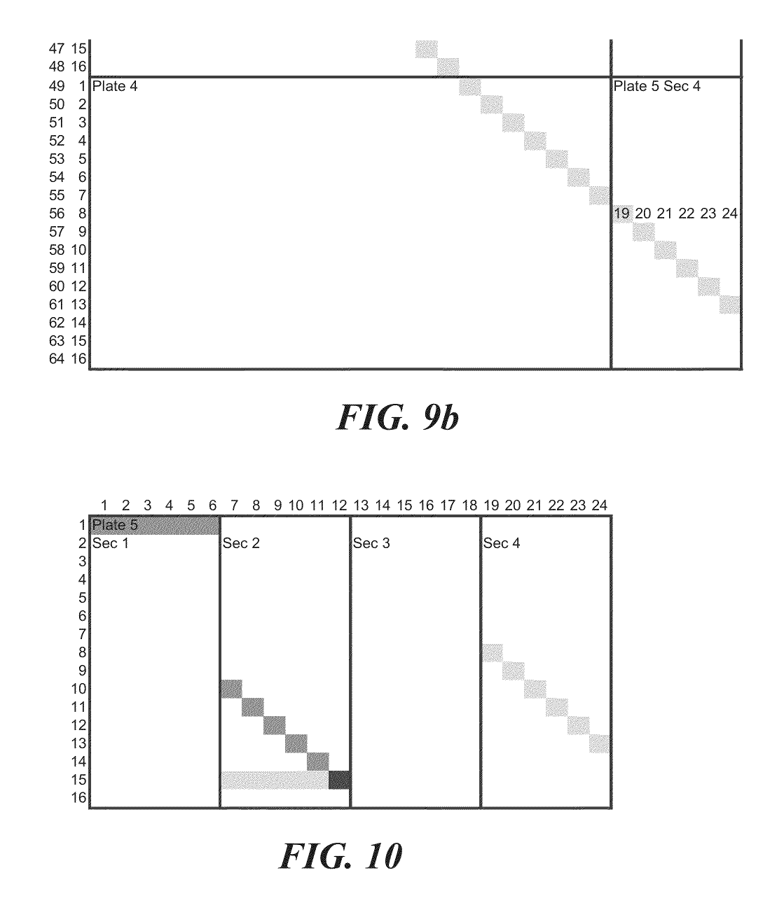

FIGS. 9a and 9b show a grid representing five 384-well plates and use of the embodiments herein for a collection of segregated substances placed in respective wells logically arranged in a two-dimensional array extending across all five plates. Only a portion of the logical array appears in FIG. 9a and it is continued to a second sheet in FIG. 9b. In the logical array of FIGS. 9a and 9b, the “columns” within the meaning of the embodiments extend along the left side of FIGS. 9a and 9b to form 64 columns using rows 1-16 of four plates. The logical array includes 30 “rows” within the meaning of the embodiments that extend along the top side of FIGS. 9a and 9b and include columns 1-24 of four plates and six additional columns of a fifth plate.

Columns 1-6 of the fifth plate labeled as section 1 form columns 25-30 for rows 1-16 rows of the logical array. Columns 7-12 of the fifth plate labeled as section 2 form columns 25-30 for rows 17-32 of the logical array. Columns 13-18 of the fifth plate labeled as section 3 form columns 25-30 for rows 33-48 of the logical array. Columns 19-24 of the fifth plate labeled as section 4 form columns 25-30 for rows 49-64 of the logical array. Darkly shaded screening pool 1 including the wells of column 1 extends across plate 1 and plate 5, section 1 as well as plate 2 and plate 5, section 2. Lightly shaded screening pool 31 including the wells of column 31 extends across plate 2 and plate 5, section 2 as well as plates 3 and 4 and plate 5, section 4. Screening pool 1 and screening pool 31 intersect at one well on plate 5 in section 2. FIG. 10 shows a grid representing the fifth 384-well plate divided into four sections and demonstrates their incorporation into the logical array of FIGS. 9a and 9b, as described above.

Using 61 experiments, the embodiment of FIGS. 9a and 9b may be used to screen 1,830 substances (=30×61) placed in respective wells of five 384-well plates. Using known row pools and column pools, 91 experiments (=30+61) would be otherwise used to screen those 1,830 substances. Thus, the number of experiments is reduced. The 61 or 91 experiments and 1,830 substances assume 24 columns and 13 rows on plate 4 are used for placing substances in wells. If more wells were used, then the location of some could not be uniquely identified with only the 61 screening pools of FIGS. 9a and 9b. If 63 screening pools were used, then all 1920 substances of all five plates could be uniquely identified. With 64 screening pools used, then 1 more screening pool than needed is used but the ease of pooling may justify the extra screening pool.

Sometimes it is advantageous to use less than ideal pooling schemes because often they allow significantly improved cost effectiveness and reduced effort with very little loss in data. It may be beneficial to gather data even when every clone cannot be absolutely deconvoluted. For example, if whole genome sequencing is one of the goals, it is not critical that every individual clone have a known sequence; only as much as possible of the genome need be known. These are examples of times when the ratio of the number of columns being 2 times the number of rows plus one is not directly followed, but just used as a guide. Since the number of individuals on a given plate is fixed by the physical choice of columns and rows, sometimes it is beneficial to have some individuals not able to be absolutely deconvoluted. The benefit of having the entire plate processed and the data gathered for all wells outweighs the circumstance that one does not know exactly which individual the data came from for all of the data or individuals.

FIG. 11 shows a grid representing twelve 384-well plates and use of the embodiments herein for a collection of segregated substances placed in respective wells logically arranged in a two-dimensional array extending across all 12 plates. In the logical array of FIG. 11, the “columns” within the meaning of the embodiments extend along the top of FIG. 11 to form 96 columns using rows 1-16 of six plates. The logical array includes 48 “rows” within the meaning of the embodiments that extend along the side of FIG. 11 and include columns 1-24 of two plates. Consequently, the logical array accommodates two plates by six plates.

For 48 rows, two times the number of rows plus one would yield 97 columns. FIG. 11 only includes 96 columns since that is the number of columns existent in a two plate by six plate array. Also, a 96-well plate is commonly used by those of ordinary skill. Each of the 96 pseudo-column pools would conveniently fit in a known 96-well plate. The 12 plates of FIG. 11 may include 4,608 segregated substances. Using 96 experiments, the embodiment of FIG. 11 may be used to screen all of such substances placed in respective wells.

Because the logical array includes 96 pools (96 columns) instead of 97 pools, pool 1 and pool 49 overlap at two wells in the same manner as discussed above regarding FIG. 7 for the circumstance where 28 screening pools are used instead of 29. That is, the diagonal of screening pool 49 (column 49) wraps around the array past column 96 to intersect with column 1. As a result, the substances of 48 wells (one of the columns) are not uniquely identified, but the data is still gathered on all of the individuals even though location is not known exactly for about 1% of the 4,608 individuals. FIG. 12 shows screening pool 1 (column 1) intersecting with screening pool 48 (column 49) at just one well. Consequently, out of 4,608 substances, one appearing in both screening pools 1 and 49 can be identified at a unique location using only 96 tests.

In comparison, the plate, row, column, diagonal intermediate subpool embodiment herein utilizing re-pooling for a 12 plate stack of 384-well plates uses 34 experiments. Even though the number of experiments is significantly lower, in practice, the complexity of a three-dimensional pooling design is significantly greater than the complexity of a one-dimensional pooling design. A known two-dimensional row pool and the column pool design screening the 12 plates would use 144 experiments (=96+48).

Accordingly, the two-dimensional to one-dimensional approach in FIG. 11 significantly reduces the 144 experiments to 96 experiments without increasing complexity of the pooling design. If a 97th pool were added by using a 13th plate, then the location of 4,656 substances could be uniquely identified. Theoretically, the three-dimensional plate, row, column, diagonal repooled design uses fewer experiments but, practically, the tests are repeated due to wide confidence intervals and the increased difficulty in deconvolution of three of more dimensions. The three-dimensional design seeks to identify the presence of an item of interest three times. Given the uncertainty of three identifications occurring, in practice, tests are repeated at least twice to avoid false negatives. Accordingly, in practice, at least 68 tests or more are used. A more narrow confidence interval exists for identifying the presence of an item of interest two times, as in the two-dimensional embodiment, so less motivation exists for repeating tests.

Further, the complexity of building the intermediate sub pool by pooling 12 plates, rows on each of 12 plates, columns on each of 12 plates, and diagonals on each of 12 plates is more time intensive in comparison to the pseudo-column pools of FIG. 11. Further, sometimes it is advantageous to directly generate the matrix pools without first physically creating the intermediate subpool. It is especially feasible if using the two-dimension to one-dimension embodiments taught herein because the liquid handling effort is significantly reduced. For many reasons, the 96 or 97 experiments of a two-dimensional design reducing to one-dimension may be beneficial in many circumstances.

In the three-dimensional pooling design, the number of experiments was reduced by first increasing the number of dimensions from three to four (from plate, row, and column to plate, row, column, and diagonal) to reduce the number of experiments and then repooling to further reduce the number. Thus, with increased dimensions, experiments were reduced. In the two-dimensional pooling design, it was determined that the number of dimensions could decrease while still reducing the number of experiments. As a result, the two-dimensional pooling design produces a surprising result.

In compliance with the statute, the embodiments have been described in language more or less specific as to structural and methodical features. It is to be understood, however, that the embodiments are not limited to the specific features shown and described. The embodiments are, therefore, claimed in any of their forms or modifications within the proper scope of the appended claims appropriately interpreted in accordance with the doctrine of equivalents.

TABLE OF REFERENCE NUMERALS FOR FIGURES

```
  2 well plate
  4 positive control
  6 negative control
  8 superpool
10 BAC library
20 superpool plate
30 plate pool
40 row pool
50 column pool
60 diagonal pool
31 plate repool
41 row repool
51 column repool
61 diagonal repool
70 well plate
80 well plate
```

The invention claimed is:

1. A substance identification method comprising:
using a collection of segregated substances placed in respective wells of a plurality of collection plates physically or logically arranged in a stack, the wells being arranged in a plurality of rows and a plurality of columns and individual substances having a unique coordinate locating a well position defined by a plate identifier, a row identifier, and a column identifier;
combining the substances into four or more intermediate subpools in respective wells of a subpool plate, the four or more intermediate subpools being of at least one type of intermediate subpool, one to four of the types of subpool being selected from the group consisting of a plate pool from wells having a common plate identifier, a row pool from wells having a common row identifier, a column pool from wells having a common column identifier, and a diagonal pool from wells having column and/or row identifiers per plate that are offset with respect to column and/or row identifiers per plate of any adjacent plate in the stack;
repooling the four or more intermediate subpools into a number of final screening pools less than the four or more intermediate subpools and placing the final screening pools in respective wells of a matrix pool plate based on a repooling design providing the subpooled substances in at least three different final screening pools;
screening the final screening pools and identifying the presence of an item of interest associated with a substance; and
using the repooling design, determining the coordinate locating the well position in the collection for the substance associated with the item of interest.

2. The method of claim 1 wherein the subpooled substances are different.

3. The method of claim 1 wherein the collection comprises a portion of a bacterial artificial chromosome library.

4. The method of claim 1 wherein the substances are selected from the group consisting of biological material clones or fragments, expressed proteins, purified proteins, materials exhibiting biological activity, chemicals expressed in biological processes, and combinations thereof and the item of interest is selected from the group consisting of a nucleotide sequence in a biological material clone or fragment, a biological activity exhibited by a material, a chemical composition, and combinations thereof.

5. The method of claim 4 wherein the substances are biological material clones comprising genomic DNA clones and the item of interest comprises a DNA nucleotide sequence in a genomic clone DNA insert.

6. The method of claim 1 wherein the substances are biological material clones and the item of interest is a nucleotide sequence, the method further comprising:
culturing the collection of clones, producing respective individual clone cultures, and forming the intermediate subpools using the individual clone cultures; and
isolating biological material fragments from the four or more intermediate subpools and storing in a stable form prior to the repooling.

7. The method of claim 1 wherein the at least one type of intermediate subpool comprises four types of subpool including the plate pool, the row pool, the column pool, and the diagonal pool.

8. The method of claim 1 wherein the offset column and/or row identifiers are offset by one column and/or row with respect to adjacent plates and are not repeated in the diagonal pool for any other plate.

9. The method of claim 1 wherein the screening is selected from the group consisting of sequencing, Polymerase Chain Reaction (PCR) probing, DNA to DNA hybridization probing, RNA to DNA probing, protein to protein probing, antibody to protein probing, DNA to protein probing, RNA to protein probing, chemical compound to protein probing, ligand to protein probing, and combinations or modifications thereof.

10. The method of claim 1 wherein the repooling design provides the subpooled substances in four to eight of the final screening pools.

11. The method of claim 1 wherein the collection is a three-dimensional array, the combining of substances uses four types of intermediate subpools to provide four-dimensions of intermediate subpools, a sum of the plurality of plates, the plurality of rows, and the plurality of columns is less than a number of the intermediate subpools sufficient to identify the well position of any substance in the array, the repooling design produces a number of final screening pools sufficient to identify the well position of any substance in the array, and the number of final screening pools is less than the sum.

12. A method for identifying an individual genomic clone DNA insert from a collection of genomic DNA clones comprising:
arraying the individual genomic DNA clones in a plurality of respective wells of a plurality of collection plates comprised of rows and columns with individual genomic DNA clones having a specific coordinate locating a well position defined by three or four pools chosen from the group consisting of a plate pool, a row pool, a column pool, and a diagonal pool in a hierarchical structure that is composed of a plate identifier, a row identifier, and a column identifier;
culturing the collection of genomic DNA clones and constructing at least four intermediate subpools by combining individual genomic DNA clone cultures in accordance with the hierarchical structure;
isolating genomic DNA clone DNA from the at least four intermediate subpools and storing in a stable form;
repooling the at least four intermediate subpools into a number of Final Screening Pools based on a chosen repooling design, wherein the subpooled individual genomic DNA clone DNA is in at least 4 Final Screening Pools and no more than 8 Final Screening Pools; and
screening the number of Final Screening Pools for a DNA sequence of interest, determining the specific coordinate using the chosen repooling design, and identifying the well position of the DNA sequence of interest.

13. The method of claim 12 wherein the collection comprises a portion of a bacterial artificial chromosome library.

14. The method of claim 12 wherein the collection plates comprise 96-well, 384-well, 864-well, or 1536-well microtiter plates.

15. The method of claim 12 wherein the hierarchical structure comprises a plate number, a row letter, and a column number.

16. The method of claim 12 wherein a complete set of intermediate subpools is constructed by combining all individual genomic DNA clone cultures in the collection in accordance with the hierarchical structure.

17. The method of claim 12 wherein the screening comprises using a screening method selected from the group consisting of sequencing, Polymerase Chain Reaction (PCR) probing, DNA to DNA hybridization probing, RNA to DNA probing, and combinations or modifications thereof.

18. A substance identification method comprising:
using a collection of segregated substances placed in respective wells physically or logically arranged in a two-dimensional array, the wells being arranged in a plurality of rows and a number of columns that is at least 1.5 times the plurality of rows and individual substances having a unique coordinate locating a well position defined by a row identifier and a column identifier;
combining the substances into a number of screening pools in respective wells of a matrix pool plate, a plurality of individual screening pools including substances from wells having a row identifier in common with one other well based on a pooling design that provides the pooled substances in two different screening pools;
screening the screening pools and identifying the presence of an item of interest associated with a substance; and
using the pooling design, determining the coordinate locating the well position in the collection for the substance associated with the item of interest.

19. The method of claim 18 wherein the pooled substances are different.

20. The method of claim 18 wherein the array resides on a plurality of microtiter well plates and at least some of the screening pools extend across a plurality of the plates.

21. The method of claim 18 wherein the number of columns is at least two times the plurality of rows.

22. The method of claim 18 wherein the number of columns is at least two times the plurality of rows plus one.

23. The method of claim 18 wherein the number of screening pools matches the number of columns.

24. The method of claim 18 wherein the collection comprises a portion of a bacterial artificial chromosome library.

25. The method of claim 18 wherein the substances are selected from the group consisting of biological material clones or fragments, expressed proteins, purified proteins, materials exhibiting biological activity, chemicals expressed in biological processes, and combinations thereof and the item of interest is selected from the group consisting of a nucleotide sequence in a biological material clone or fragment, a biological activity exhibited by a material, a chemical composition, and combinations thereof.

26. The method of claim 25 wherein the substances are biological material clones comprising genomic DNA clones and the item of interest comprises a DNA nucleotide sequence in a genomic clone DNA insert.

27. The method of claim 18 wherein the substances are biological material clones and the item of interest is a nucleotide sequence, the method further comprising:
culturing the collection of clones, producing respective individual clone cultures, and forming the screening pools using the individual clone cultures; and
isolating biological material fragments from the screening pools and storing in a stable form prior to the screening.

28. The method of claim 18 wherein the screening is selected from the group consisting of sequencing, Polymerase Chain Reaction (PCR) probing, DNA to DNA hybridization probing, RNA to DNA probing, protein to protein probing, antibody to protein probing, DNA to protein probing, RNA to protein probing, chemical compound to protein probing, ligand to protein probing, and combinations or modifications thereof.

29. The method of claim 18 wherein the pooling design provides screening pools from contiguous wells.

30. The method of claim 18 wherein the pooling design reduces the two-dimensional array to a one-dimensional array.

31. The method of claim 30 wherein the one-dimensional array comprises:
pseudo-column pools from a plurality of wells having a common column identifier and another equal number of wells having a row identifier in common with the plurality of wells; or
bi-diagonal pools from a plurality of wells that do not have row or column identifiers in common and another equal number of wells having a row identifier in common with the plurality of wells.

32. The method of claim 31 wherein the other number of wells in the pseudo-column pools or the bi-diagonal pools do not have row or column identifiers in common.

33. The method of claim 18 wherein the pooling design reduces a part of the two-dimensional array to a one-dimensional array and the screening pools from another part of the two-dimensional array form screening pools in a second dimension.

34. The method of claim 18 wherein a number of the screening pools sufficient to identify the well position of any substance in the array is less than a sum of the plurality of rows and the number of columns.
